(19) United States
(12) Patent Application Publication
(10) Pub. No.: US 2023/0345958 A1
(43) Pub. Date: Nov. 2, 2023

(54) SOLID FAT TRIGLYCERIDE COMPOSITION

(71) Applicant: Upfield Europe B.V., Amsterdam (NL)

(72) Inventors: Georg Christian DOL, Amsterdam (NL); Ronald Peter POTMAN, Amsterdam (NL); Irene Erica SMIT-KINGMA, Amsterdam (NL); Marc Jules A. KELLENS, Amsterdam (NL)

(21) Appl. No.: 18/042,202

(22) PCT Filed: Aug. 20, 2021
(86) PCT No.: PCT/EP2021/073202

§ 371 Date: Feb. 17, 2023

(30) Foreign Application Priority Data
Aug. 21, 2020 (EP) 20192181.4

(51) Int. Cl. A23D 7/02; A23D 7/00; A23D 7/015; C11C 3/08

(52) U.S. Cl. CPC A23D 7/02; A23D 7/001; A23D 7/015; C11C 3/08

(57) ABSTRACT

The invention pertains to a process for the preparation of a fat comprising enzymatic transesterification of an oil with a fatty acid mixture having more than 80 wt. % fatty acids of the H type to provide a triglyceride mixture containing more than 60% saturated fatty acids and with a high degree of saturation on the 2-position and a triglyceride mixture obtained thereby.

### FIELD OF THE INVENTION

The present invention pertains to a method for the preparation of a high stearic acid fat>the invention also pertains to a high stearic acid fat. The high stearic acid fat composition of the invention finds application in a method wherein the high stearic acid fat is used for the preparation of a structuring fat and the use of the structuring fat in food compositions and food compositions comprising the fat.

### BACKGROUND OF THE INVENTION

Food composition comprising fats and oils such as spreads, margarine and the like whether in the form of water in oil (w/o) or oil in water (o/w) emulsions typically contain blends of structuring fats or solid fats and oil (often vegetable oil).

The structuring or solid fat provides the structure and texture to the resulting oil and water emulsion by crystallisation of the fatty acids of the triglycerides in the blend and the resulting food. Typically, structuring fats contain more saturated and longer chain fatty acids. Vegetable oils typically contain more unsaturated fatty acids and are usually liquid at room temperature. In order to incorporate suitable amounts of fats and oils in consumer products like spread and margarines, blends are made from natural solid fats (structuring fats) and oils wherein the solid fat (also known in the art as hard stock) provide the structure to incorporate oil into the emulsion.

Hydrogenation is a process of hardening fats and oils by converting unsaturated fatty acids in fats and oils to saturated fats. Hardening of fats is an efficient way of improving the structuring properties of fat and oils. Hydrogenation is perceived by consumers as a non-natural way of adapting fat compositions. Hydrogenation of fats to improve the structure of the resulting fat is less preferred as consumers are increasingly focused on having products that have a more natural origin. Incomplete or partial hydrogenation also results in products having increased levels of trans-fatty acids. Trans-fatty acids are considered less desirable in view of health considerations. There is hence also a need for fat blends that have a low content of trans-fatty acids.

In the art, attempts have been made to improve on the structuring features of fats to come to fat blends that have desired texture and melting profiles and/or are suited for specific applications, such as chocolate butter equivalent (CBE).

To adapt the fat composition of fat blends suitable for CBE, EP2508078 describes the transesterification of a POP-containing palm-based fat with excess stearic acid or stearic acid ester using a 1, 3 position-specific lipase such as from the genus of Rhizopus, Mucor, Aspergillus, Alcaligenes, Humicola. The result was a fat with a POS content that was increased from about 8 to about 50% and the fat was suitable as a cocoa butter equivalent.

Also US2015056361 describes the transesterification of High Oleic Sunflower Oil with fatty acid esters like ethyl stearate using an 1, 3-specific enzyme to yield cocoa butter equivalents.

US20140272082 described 1,3-position specific enzymatic transesterification of high stearic sunflower oil with ethyl stearate for use in confectionary as a CBE.

US20100255152 uses 1,3-position specific lipase like Rhizopus oryzae and/or Rhizopus delemar to make hard butter as a CBE in the enzymatic transesterification using triglycerides having oleoyl and/or linoleoyl fatty acids at the 2- position of the glycerol backbone to generate fats that are rich in SOS and/or SLS.

U.S. Pat. No. 4,861,716 describe the transesterification process to produce CBE fats rich in POS and SOS by using a 1,3-selective lipase in the enzymatic transesterification of a mid-fraction of palm oil and myristic acid or stearic acid and of a shea oil fraction with stearic acid. Low levels of SSS were produced and predominantly SOS.

U.S. Pat. No. 4,268,527 describes the production of a CBE fat by transesterification contain glycerol rich in the oleyl moiety at the 2-position with a C16:0 or C18:0 ester using a 1,3-specific lipase to make SOS and POS rich fats.

U.S. Pat. No. 4,364,868 describes the preparation of a CBE fat rich in POP, POS and SOS by transesterification a palm oil (PO) mid fraction with stearic acid using a aspergillus lipase (1,3-selective).

WO16200324 describes the 1,3-specific transesterification of stearic acid esters with High Stearic Sunflower oil (HSSO) to further increase the endothermic melting peak to make fats for confectionary use based on SatOSat or SOS triglycerides.

WO2005003365 describes the use of lipase catalysts to rearrange fatty acids on the glycerol backbone. WO2005071053 describes processes for randomising fatty acid residues over the terminal and middle positions using a Thermomyces lanuginosa lipase.

Berben P H, Groen C, Christensen M W, Holm H C: Interesterification with immobilized enzymes. Society of Chemical Industry. 2000, 121: 1-2 described a process for the enzymatic rearrangement of triglycerides until an equilibrium was reached and provided a randomisation at the middle position of 18%.

In general, fats or fat products having a high saturated content such as POP or SOS triglycerides suffer from what is known in the art as graininess or sandiness, an unpleasant mouthfeel. The effect is attributed to the formation of fat crystals. Furthermore, SSS triglycerides are also seen as cumbersome as in food applications in view of a waxy mouthfeel. Products that express these effects generally experience a lower consumer acceptance level.

The present inventors have set out to develop triglyceride fats that have a relative low level of POP, SOS and/or SSS to avoid the disadvantages thereof, while at the same time having an increased level of saturation. Based on these fats, structuring fats or hard stock fats can be developed that are suitable for the development of adequate consumers products can be developed such as margarines, spreads etc.

The inventors found that by increasing the amount of stearic (or palmitic) acid in the triglyceride, by focussing on increasing the P and/or S content and in particular increasing the P and/or S content on the 2-position, an improved triglyceride composition could be obtained. However, in general there is a disincentive to do so as it inherently also leads to the generation of fats containing higher amounts of trisaturated triglycerides such as SSS triglycerides.

Thus there remains a need for processes to make a fat with even higher amounts of saturated, long chain fatty acids and for fats that have relative high amount of saturated, long chain fatty acids, yet avoid sandiness, graininess or waxiness and have low level of trans fat.

### SUMMARY OF THE INVENTION

The present inventors have found processes that allow the generation of structuring fats with improved properties and/or applications. The invention encompasses processes to make structuring fats having increased levels of saturated long chain fatty acids (H: S or P), the resulting structuring fat having increased levels of H fatty acids, improved (lower) level of trans fatty acids, especially on the 2-position, methods for making structuring fats that can be, optionally after further blending and or interesterification with other fats and/ or oils to obtain other structuring fats, applied in applications such as spreads and margarines and applications.

Some of the advantages of having structuring fats available that have a higher content of long chain (H) fatty acids, preferably stearic acid (S) containing structuring fats are that lower amounts of structuring fats can be needed and more liquid oil can be used in the applications for spreads and margarines and the like. This further improves the naturalness of the resulting product, improves nutritional value and is also reduces cost, which is a relevant factor in this field.

A first aspect of the invention comprises enzymatic transesterification of a fat with free fatty acids, optionally with a fatty acid mixture high in long chain saturated fatty acids (more than 90% C18:0, stearic acid) using a (random or a-specific) lipase. This forms the basis of a process to come to fats that have an improved content of saturated long chains fatty acids (H), a High Stearic fat or sometimes denoted as a base or feed stock, comprising more than 60% saturated fatty acids.

In a second aspect, the invention pertains to a fat having a high content of long chain saturated fatty acids (comprising more than 60% saturated fatty acids of the H type), a High Stearic fat.

The High Stearic fat of the invention is characterised in comprising more than 60% saturated fatty acids of the H type.

### BRIEF DESCRIPTION OF THE FIGURES

FIG. 1: Schematic representation of the method of the invention for preparing a triglyceride mixture having a high SAFA content in one step via the enzymatic transesterification of an oil (or fat), relatively low in SAFA and high in unsaturated fats (bend lines 3, glycerol backbone indicates as dotted line 1) with a fatty acid mixture relatively high in SAFA (straight lines 2) and a fraction of free fatty acids.

FIG. 2: Schematic representation of the method of the invention for preparing a triglyceride mixture having a high SAFA content in a two-step procedure step via the enzymatic transesterification of an oil (or fat), relatively low in SAFA and high in unsaturated fats (bend lines) with a fatty acid mixture relatively high in SAFA (straight lines). The triglyceride mixture obtained from the first step is reacted again with the (same or different) fatty acid mixture in a second transesterification steps, which may be with the same of a different enzyme.

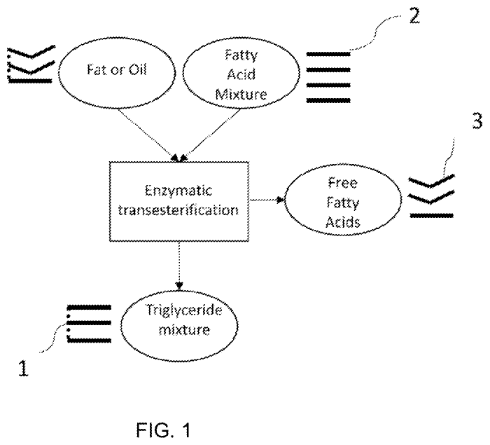

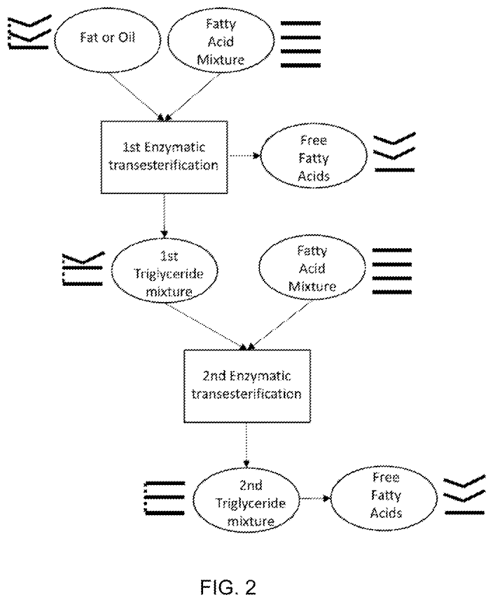

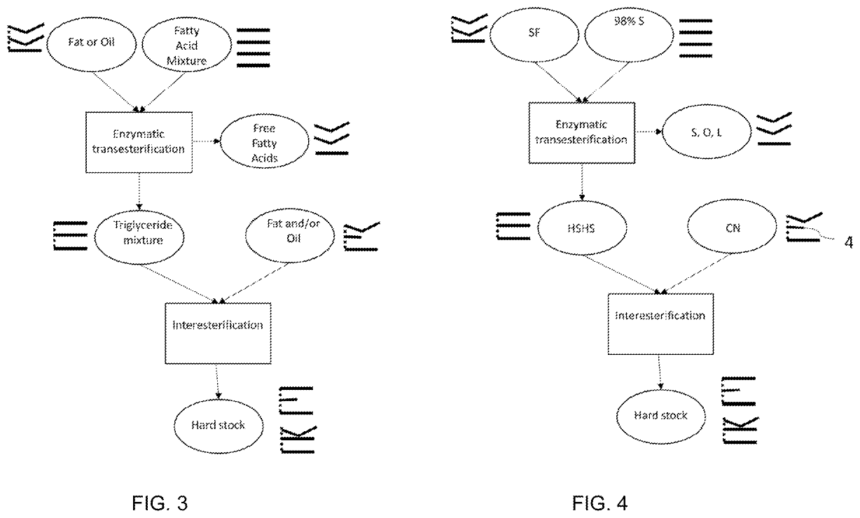

### DETAILED DESCRIPTION

The term “oil” or “liquid oil” is typically used for triglyceride compositions that that are liquid at room temperature. The term “liquid oil” is used for triglycerides that are liquid at room temperature, preferably also liquid at temperature below room temperature such as below 15, 10 or 5° C. Preferably the solid fat content of the liquid oil is 0 at 20° C., more preferably it is 0 at 15° C.

The term “fat”, is typically used for triglyceride compositions that that are solid at room temperature. The use of the term “oil” or “fat” is hence interchangeable depending on the circumstances that are clear and known in the art.

A fat is typically used for structuring a fat composition, i.e. to provide a structure and texture in admixture with an oil or other fat. It can also be indicated as a structuring fat or hard stock fat The fat may comprise two or more different hard fats (a blend), but is preferably a single fat. The fat may be an interesterified mixture of one or more fats.

A “margarine fat” is a fat blend which is suitable for use as a fat in spreads, both fat-continuous and water-continuous, such a margarine fat usually includes a fat and a liquid oil.

Solid fats from which lower melting constituents have been removed are typically indicated as “stearin fractions”. A stearin fraction for the purpose of this description is defined as a triglyceride mixture or fat blend from which at least 10% of the lower melting constituents have been removed by some kind of fractionation, e.g. dry fractionation, multi-stage countercurrent dry fractionation or solvent fractionation. The lower melting constituents are indicated as “olein fraction”.

The fat fraction can also be characterized by a triacylglyceride or TAG profile. In the TAG profile and throughout this application, the following abbreviations are used:

| | |
|---|---|
| M | Medium chain fatty acid (C12-C14) |
| H | Saturated long chain fatty acid >= C16 |
| P | Palmitic acid C16:0 |
| S | Stearic acid, C18:0 |
| U | Unsaturated fatty acid |
| O | Oleic acid C18:1 |
| L | Linoleic acid/linolenic acid C18:2, C18:3 |
| St | Saturated fatty acid |
| HUH | Symmetrical triglyceride |
| H2U/StStU | Disaturated triglyceride |
| HU2/StUU | Monosaturated triglyceride |
| U3 | Unsaturated triglyceride |
| H3/StStSt | Long chain saturated fatty acid triglyceride |
| H2M | Mixed (2 long, 1 medium) chain fatty acid triglyceride |
| M3 | Medium chain fatty acid triglyceride |
| Sh | Short chain fatty acid (C4-C10) |
| X | Any fatty acid (H, U or Sh) |

In this specification all parts, proportions and percentages are by weight; the amount of fatty acids in an oil or fat is based on the total amount of fatty acids in the oil or fat and the amount of fat in the fat composition is based on the total weight of the fat composition, unless otherwise stated.

The solid fat content (SFC) in this description and claims is expressed as N-value, essentially as defined in Fette, Seifen Anstrichmittel 80 180-186 (1978). The stabilisation profile applied is heating to a temperature of 80° C., keeping the oil for at least 10 minutes at 60 ° C. or higher, keeping the oil for 16 hours at 0° C. and then 30 minutes at the measuring temperature, except where indicated otherwise.

Non-hydrogenated means that the fat or oil has not undergone any hydrogenation treatment. This entails the fats as well as blends and interesterified mixtures of the fats. Non-hydrogenated fats have essentially no trans-fatty acids. Preferably the fat of the invention has less than 5 wt. % , preferably less than 2 wt. % , of trans fatty acids, more preferably less than 1 wt. %, 0.5, 0.1 wt. % or even 0 wt. % (non-detectable using analysis methods common in the art)

Conventionally, partially hardened fats typically has as one of its disadvantages a relative high level of trans fat. Conventionally partially hardened fats are made by partial hydrogenation of an oil, typically a highly unsaturated oil. A highly unsaturated oil, such as sunflower oil, contains a high amount of unsaturated fatty acids (typically more than 90%), also at the 2-position. Partial hardening through hydrogenation is known to lead to the formation of trans-fatty acids, also at the 2-position. The fat of the invention is obtained by enzymatic transesterification with saturated free fatty acids. This avoids trans-fat formation and leads to a fat that has an inherently lower trans-fat level, also on the 2-position. At the same time, the fat of the invention can still contain a certain level of unsaturated fatty acids. In the known highly saturated fats, the fat has appeared to crystallize as coarse grains, which are unacceptable for a spread which ought to possess a smooth appearance and mouthfeel. Such effect is known in the art as sandiness or graininess.

In the case of sandiness the particles have higher melting points, they do not melt so readily when rubbing them between the fingers. The well-known graininess consists of particles which also melt at relatively low temperature but the particle sizes are much smaller. It is known in the art that such effects are caused by fats that are high in POP and SOS.

By increasing the level of saturation at the 2-position using the method of the invention, the formation of POP and SOS is reduced and the method and resulting fat of the invention thus avoids the sandiness or graininess. This is determinable for instance by mouthfeel or by microscopy. At the same time due to the presence of a certain amount of unsaturation, the waxiness mouthfeel known from other fats that are highly saturated such as SSS or fully saturated sunflower oil (SF69) can be avoided.

Interesterification and transesterification are a methods for adapting the fatty acid composition of a fat composition.

Interesterification as used in the present disclosure and distinguished in the present disclosure from transesterification refers to the exchange of fatty acids between triglycerides in a triglyceride mixture. In interesterification, the total fatty acid composition of the triglyceride mixture remains substantially the same, yet the distribution of the fatty acids over the glycerol backbone may be different. Interesterification typically results in a redistribution of the fatty acids over the glycerol backbone.

Transesterification, as used in the present disclosure and distinguished in the present disclosure from interesterification, refers to the exchange of fatty acids between fatty acids (or fatty acid esters) and triglycerides. In transesterification, the total fatty acid composition of the triglyceride mixture changes. Transesterification results in a different fatty acid composition of the triglyceride mixture.

In a first aspect, the invention pertains to a method for the preparation of a fat comprising the steps of
a. providing an oil;
b. providing a fatty acid mixture having more than 80 wt. % of fatty acids of the H-type drawn on the fatty acid mixture;
c. subjecting the oil with the fatty acid mixture to enzymatic transesterification to provide a fat mixture comprising
   i. a triglyceride mixture, which triglyceride mixture contains more than 60% fatty acids of the H-type drawn on the total amount of fatty acids in the triglyceride mixture, and optionally
   ii. free fatty acids;
d. optionally, removing free fatty acids from the fat mixture
e. optionally, isolating the triglyceride mixture.

The oil (or starting oil) in the method of the present invention can be any edible oil, but is preferably a vegetable oil. The vegetable oil can be selected from amongst coconut oil, palm oil, palm kernel oil, rapeseed oil, linseed oil, soy bean oil, maize oil, sunflower oil or fractions and mixtures thereof. There is a preference for rape seed oil or sunflower oil and mixtures thereof.

The oil in the method of the present invention is preferably not a palm oil or palm oil-based or -derived oil (palm oil fractions). The oil in the method of the present invention is preferably non-hydrogenated.

The fatty acid mixture of the present invention can be a mixture of fatty acids and contains preferably more than 80 wt. % of saturated fatty acids. The wt. % of the fatty acid mixture is drawn on the total amount of fatty acids in the fatty acid mixture. More preferable the fatty acid mixture contains more than 85 wt. % of saturated fatty acids and even more preferred more than 90 wt. % of saturated fatty acids. A percentage of more than 95 or even more than 98 or 99 wt. % of saturated fatty acids is highly preferred in the fatty acid mixture. The fatty acid mixture may also be composed of one single fatty acid, preferably stearic acid or palmitic acid or a mixture of stearic and palmitic acid.

In a preferred embodiment, the amount of unsaturated fatty acids in the fatty acid mixture is less than 20 wt. %, preferably less than 15 wt. %, even more preferably less than 10 or 5 wt. %. In highly preferred embodiment, the amount of unsaturated fatty acids in the fatty acid mixture is less than 3 wt. %, and even more preferred less than 2 or 1 wt. %.

The fatty acid mixture is typically rich in saturated fatty acids, more preferably rich in H (H=P or S) saturated fatty acids. The fatty acid mixture thus, in embodiments, preferably comprises more than 85 wt. % of saturated fatty acids of the H type and even more preferred more than 90 wt. % of saturated fatty acids of the H type. A percentage of more than 95, 98, 99 wt. % of saturated fatty acids of the H type is highly preferred in the fatty acid mixture. T

he fatty acid mixture is preferably rich in stearic acid (C18:0, S) fatty acids. The fatty acid mixture typically contains more than 50 wt. % stearic acid (C18:0) fatty acids or even more than 60 wt. %. The fatty acid mixture thus preferably comprises more than 75, 80 or 85 wt. % of saturated fatty acids of the S type and even more preferred more than 90 wt. % of saturated fatty acids of the S type. A percentage of more than 95, 98, 99 wt. % of saturated fatty acids of the S type is highly preferred in the fatty acid mixture as it further increases the level of saturation in the resulting triglyceride and preferably on the 2-position thereof.

The fatty acid mixture can comprise H-type saturated fatty acid esters in a ratio of saturated C16/C18 of 30/70 (30 parts by weight of C16 and 70 parts C18), 20/80, 10/90 preferably 5/95, more preferably 1/99.

The fatty acid mixture is preferably provided in the method of the invention in an excess, preferably a stoichiometric excess, compared to the oil. Since the transesterification reaction is an equilibrium reaction, an excess of the fatty acid mixture is provided to push the equilibrium in the desired direction. The excess is drawn on the amount of TAGs or FAs (1 TAG=3FA) initially provided. The amount of fatty acids in the fatty acid mixture is provided in a fivefold excess, preferable a tenfold excess drawn on the amount of oil, calculated as molar equivalents of fatty acids vs triglycerides. So, for example, a fivefold excess of fatty acids means 5 molar equivalents of FAA on one molar equivalent of a triacylglyceride mixture. Alternatively, the excess can be calculated based on weight equivalents, i.e. wt. % oil and wt. % fatty acid mixture drawn on the total reaction mixture. Thus, a weight equivalent excess of 2 indicates 1:2 of oil: fatty acid mixture, corresponding to 33.3 wt. % oil and 66.6 wt. % fatty acid mixture on the total reaction mixture.

In preferred embodiments, the weight ratio of the fatty acid mixture to oil is 1.5, preferably 2.5, more preferably 4, even more preferably 7.5. as higher ratio's may push the equilibrium of the transesterification further, they are preferred but high ratio's also increase cost, so a typical ratio is 2.5.

In one embodiment, the fatty acid mixture can contain or consist of chemically pure fatty acids such as obtained from hydrolysis of triglycerides or chemically pure fatty acid esters. In one embodiment, the fatty acid mixture can be a distillate or concentrate from a hydrolysed (optionally non-palm) vegetable oil or fat. The fatty acid mixture can be obtained from a distillate or concentrate from hydrolysed coconut oil, palm oil, palm kernel oil, rapeseed oil, linseed oil, soy bean oil, maize oil, sunflower oil, safou oil, mango butter, phulwara butter, sal butter, bacuri shea butter, kokum butter, allanblackia, algae or mixtures thereof, preferably from coconut oil, palm kernel oil, rapeseed oil, linseed oil, soy bean oil, maize oil, sunflower oil or mixtures thereof. Preferably, the fatty acid mixture is not obtained from palm oil.

In the method of the invention, the enzymatic transesterification can be a random transesterification. The random transesterification can be a one-step transesterification using a random lipase. Random lipases are known in the art such as Novozyme 435 random Lipase, an immobilized form of Candida antarctica. Another suitable lipase is known in the art as Lipozyme TLIM (Novozyme) which is a 1, 3-specific lipase originating from Thermomyces lanuginosis immobilized on a carrier that rearranges, but not uniquely, in the 1-3 position of triglycerides. There is a preference for a 1, 3-specific lipase originating from Thermomyces lanuginosis immobilized on a carrier, such as Lipozyme TLIM from Novozyme Denmark

Using a random lipase allows for transesterification at all three positions of the glycerol backbone and thus can increase the H content of the resulting transesterified fat further. Using the method of the invention starting with a conventional or commercially available starting oil or fat, a H-content can be achieved in the resulting triglyceride mixture that exceeds the H-level in the starting oil or fat and in particular that exceeds a H-level at the 2 position (SN2) that is higher than in the starting oil or fat. This imparts additional and advantageous properties to the resulting transesterified fat in terms of structuring capabilities or its use for making other fats and improving their structuring capabilities.

In one embodiment, the transesterification is a two-step transesterification using the same enzyme in both steps. The same enzyme in the two step transesterification can a random or a 1,3-specific lipase.

In one embodiment, the random transesterification is a two-step transesterification using a combination of a random lipase and a 1,3-specific lipase. This can be done in both steps, each step a combination of a random lipase and a 1,3-specific lipase.

Thus, in one embodiment the first transesterification is with a 1,3-specific lipase and the second transesterification with a random lipase. In an alternative embodiment, the first transesterification is with a random lipase and the second transesterification with a 1,3-specific lipase.

The methods of the invention may be performed in a suitable solvent which are in themselves known in the art, such as petroleum ether. It is preferred that the methods of the invention are performed in absence of a solvent.

The methods of the invention may be performed in a suitable temperature range which are in themselves known in the art or can be determined by the skilled person, such as between 50 and 75 degrees Celsius and preferably at a combination of the optimum temperature for the enzyme and a substantially liquid transesterification mixture. There is a preference for a temperature between 60 and 75 degrees Celsius, 68-74 degrees Celsius, more preferably between 69 and 72 degrees Celsius for example about 70 degrees Celsius.

After the (one or two step) transesterification, the reaction mixture will comprise a transesterified triglyceride mixture and free fatty acids. The transesterified triglyceride mixture will, as a consequence of the transesterification, have a different fatty acid composition than the starting oil or fat and the free fatty acids will have a different fatty acid composition than the fatty acid mixture that entered the reaction. The free fatty acids as well as the triglyceride mixture may be (partly) separated from the reaction mixture, for instance by stripping, distillation, fractionation or other known means in the art.

In certain embodiments, when a process is used with a two-step enzymatic transesterification encompassing a first transesterification with a first lipase and a first fatty acid mixture, the reaction mixture can be separated (partly) from the free fatty acids and the separated reaction mixture can be subsequently contacted with the same or a different fatty acid mixture with a preferred fatty acid composition as specified herein elsewhere for the first fatty acid mixture for a second transesterification with a second lipase. The first lipase may be a random or selective lipase. The second lipase may be a random or selective lipase. Preferably the first and second lipase together are a random an a specific lipase such that the two step transesterification employs both types of lipase consecutively in any order (random followed by specific or specific followed by random).

The enzyme can be used in amount ranging from 1-20 wt. % drawn on the amount of oil, preferably in an amount of 2-15 wt. %, more preferably 3-10 wt. %. The enzyme can be re-used.

The transesterification can be performed as long as necessary to achieve the desired level of conversion. Typically reaction times will also depend on the amount of enzymes, the excess fatty acid mixture and the temperature. However there is preference for at least 12 hours, preferably at least 18 hours, more preferably more than 24 hours, even more preferably more than 36 hours or more than 48 hours.

Good results have been obtained with a reaction time of between 12 and 36 hours with 3-10 wt. % enzyme at a temperature of 68-72 degrees Celsius in both one steps and two step transesterifications, preferably with Novozyme's lipozyme TLIM.

In a preferred embodiment, process steps may be repeated. Thus, the triglyceride mixture as a product of the transesterification may be subjected to a second transesterification with the same or a different fatty acid mixture in the same or a different amount. The same or a different enzyme may be used in the same or a different amount.

In more detail, the two-step method comprises
a. providing an oil;
b. providing a first fatty acid mixture;
c. subjecting the oil with the first fatty acid mixture to enzymatic transesterification to provide a first fat mixture comprising
   i. a first triglyceride mixture, and
   ii. first free fatty acids;
d. removing the first free fatty acids from the fat mixture
e. subjecting the first triglyceride mixture with a second first fatty acid mixture to enzymatic transesterification to provide a second fat mixture comprising a second triglyceride mixture, and
f. removing the second free fatty acids from the second fat mixture;
g. isolating the second triglyceride mixture.

In this two-step embodiment, the embodiments as described herein elsewhere in the context of a single step transesterification using one or two lipases apply mutatis mutandis.

The process of the invention result in a triglyceride mixture that is increased in the relative amount of saturated fatty acids compared to the starting fat or oil. In certain embodiments of the process of the invention the triglyceride mixture can comprise more than 60, 65 or 70 wt. % of saturated fatty acids drawn on the total amount of fatty acids in the triglyceride mixture, preferably more than 80 or 85 wt. %, preferably more than 90 wt. %, preferably more than 95 wt. %.

The triglyceride mixture of the process of the invention can comprise more than 60 wt. % of C18:0 drawn on the total amount of fatty acids in the triglyceride mixture, preferably more than 65 wt. %, preferably more than 70 wt. % , preferably more than 75 wt. %, preferably more than 80 wt. %.

The triglyceride mixture of the process of the invention differs from a partly hydrogenated triglyceride mixture having essentially the same TAG profile in the inherently lower level of trans-fats since the process of the invention does not lead to trans-fatty acid formation, whereas the partly hydrogenation does lead to the undesired formation of trans-fatty acid formation.

The triglyceride mixture obtained through the process of the invention has a relative high content of long-chain saturated fatty acids (H=P or S) and is sometimes indicated herein as a High Stearic (HS) Fat (HSF) or base stock.

The triglyceride mixture of the process of the invention can comprise triglycerides of the HHH (StStSt) type in an amount of more than 30, 31, 32, 33, 34, 35 wt. %.

In the triglyceride mixture of the process of the invention, the sum of triglycerides containing at least one saturated long chain fatty acid (P or S), StStSt+StStU+StUU, in the triglyceride mixture can be more than 90, 92, 93, 94, 95, 96, 98, 99 wt. % drawn on the total amount of triglycerides in the triglyceride mixture.

In embodiments of the method of the present invention, the ratio of the sum of triglycerides containing at least two saturated long chain fatty acids (P and/or S), StStSt+StStU, to the sum of triglycerides containing at least one saturated long chain fatty acid (P and/or S), StStSt+StStU+StUU, (StStSt+StStU)/(StStSt+StStU+StUU) in the triglyceride mixture can be more than 0.70, 0.75, 0.80, 0.85, 0.90, 0.95, 0.98.

In the method of the present invention, the result of the transesterification is preferably that the degree of transesterification is more than 75, 76, 77, 77, 78, 79, 80, 85, 90, 95%.

In the method of the present invention, the triglyceride mixture can contain more than 50, 55, 60, 65, 70, 75, 80, 85, 90, 95% of the fatty acids at the 2-position of the triglyceride of the H-type.

In the method of the present invention, the triglyceride mixture can comprise between 50-95, 55-90, 60-85, 65-80, 70-75 wt. % at the 2-position of the triglyceride of the H-type.

In the method of the present invention, the triglyceride mixture can comprise between 65-95, 66-90, 67-85, 68-80, 69-75 wt. % of saturated fatty acids drawn on the total amount of fatty acids in the triglyceride mixture.

In the method of the present invention, triglyceride mixture can comprise between 60-80, 61-75, 62-70 wt. % of C18:0 drawn on the total amount of fatty acids in the triglyceride mixture.

In the method of the present invention, the triglyceride mixture can comprise triglycerides of the StStSt type in an amount between 30-35, 31-34, 32-33% by weight drawn on the total amount of triglycerides in the triglyceride mixture.

In the method of the present invention, the amount of StStSt+StStU+StUU in the triglyceride mixture can be between 90-99, 91-98, 92-97, 93-96% drawn on the total amount of triglycerides in the triglyceride mixture.

In the method of the present invention, the ratio (StStSt+StStU)/(StStSt+StStU+StUU) in the triglyceride mixture can be between 0.70-0.98, 0.75-0.95, 0.80-0.90.

In the method of the present invention, in the triglyceride mixture between 50-95, 55-90, 60-85, 65-80% of the fatty acids at the 2-position of the triglyceride can be of the H-type.

In the method of the present invention, in the triglyceride mixture between 2-10, 3-9, 4-8, 5-7 % of the saturated fatty acid at the 2-position of the triglyceride can be of the C16:0 type.

In the method of the present invention, in the triglyceride mixture between 50-90, 55-85, 60-80, 65-75% of the fatty acids at the 2-position of the triglyceride can be of the C18:0-type.

In the method of the present invention, the triglyceride mixture can contain less than 2, 3, 4, 5, 6, 7, 8, 9, 10% of the fatty acids at the 2-position of the triglyceride of the C16:0 type.

In the method of the present invention, the triglyceride mixture can contain more than 50, 60, 70, 75, 80, 85, 90% of the fatty acids at the 2-position of the triglyceride of the C16:0 type.

In the method of the present invention. the trialvceride mixture can have an SFC profile of

| | | pref |
|---|---|---|
| Temperature | % | % |
| 5° C. | >70 | >75 |
| 10° C. | 65-77 | 68-75 |
| 20° C. | 45-62 | 55-60 |
| 30° C. | 30-65 | 35-55 |
| 35° C. | 25-50 | 30-45 |

In the method of the present invention, the triglyceride mixture can contain less than 35, 30, 20, 10, 5 wt. % of unsaturated fatty acids.

In the method of the present invention, the triglyceride mixture can contain less than 5 wt. % of trans fatty acids, more preferably less than 1 wt. %, 0.5, 0.1 wt. % or even 0 wt. % (non-detectable using analysis methods common in the art).

### Triglyceride Mixture

The triglyceride mixture obtained through the process of the invention is an invention in itself and as such form a second aspect of the invention.

The triglyceride mixture has a relative high content of long-chain saturated fatty acids (H=P or S) and is sometimes indicated herein as a High Stearic (HS) Fat (HSF) or feed stock or base stock. The triglyceride mixture has in particular high content of saturated fatty acids on the 2-position of the glycerol backbone (SN2 position).

Thus in a second aspect, the invention pertains to a triglyceride mixture (High Stearin Fat, HSF).

This aspect of the invention is characterized in that the triglyceride mixture comprises more than 60 wt. % of saturated fatty acids drawn on the total amount of fatty acids in the triglyceride mixture.

The triglyceride mixture is increased in the relative amount of saturated fatty acids compared to the starting fat or oil. In certain embodiments of the triglyceride mixture of the invention the triglyceride mixture can comprise more than 60, 65 or 70 wt. % of saturated fatty acids drawn on the total amount of fatty acids in the triglyceride mixture, preferably more than 80 or 85 wt. %, preferably more than 90 wt. %, preferably more than 95 wt. %.

The triglyceride mixture can comprise more than 60 wt. % of C18:0 drawn on the total amount of fatty acids in the triglyceride mixture, preferably more than 65 wt. %, preferably more than 70 wt. % , preferably more than 75 wt. %, preferably more than 80 wt. %.

The triglyceride mixture can comprise between 65-95, 66-90, 67-85, 68-80, 69-75 wt. % of saturated fatty acids drawn on the total amount of fatty acids in the triglyceride mixture The triglyceride mixture can comprise between 60-80, 61-75, 62-70 wt. % of C18:0 drawn on the total amount of fatty acids in the triglyceride mixture.

The triglyceride mixture can comprise triglyceride of the HHH (StStSt) type in an amount of more than 30, 31, 32, 33, 34, 35 wt. %. The triglyceride mixture comprises triglycerides of the StStSt type in an amount between 30-35, 31-34, 32-33% by weight drawn on the total amount of triglycerides in the triglyceride mixture.

In the triglyceride mixture the sum of triglycerides containing at least one saturated long chain fatty acid (preferably P or S), StStSt+StStU+StUU, in the triglyceride mixture can be more than 90, 92, 93, 94, 95, 96, 98, 99 wt. % drawn on the total amount of triglycerides in the triglyceride mixture.

The amount of StStSt+StStU+StUU in the triglyceride mixture can be between 90-99, 91-98, 92-97, 93-96 wt. % drawn on the total amount of triglycerides in the triglyceride mixture. In the triglyceride mixture of the present invention, the ratio of the sum of triglycerides containing at least two saturated long chain fatty acids (preferably P and/or S), StStSt+StStU, to the sum of triglycerides containing at least one saturated long chain fatty acid (preferably P or S), StStSt+StStU+StUU, (StStSt+StStU)/(StStSt+StStU+StUU) in the triglyceride mixture can be more than 0.70, 0.75, 0.80, 0.85, 0.90, 0.95, 0.98. The ratio (StStSt+StStU)/(StStSt+StStU+StUU) in the triglyceride mixture can be between 0.70.- 0.98, 0.75-0.95, 0.80-0.90.

The triglyceride mixture can contain more than 50, 55, 60, 65, 70, 75, 80, 85, 90, 95% of the fatty acids at the 2-position of the triglyceride of the H-type.

The triglyceride mixture can comprise between 50-95, 55-90, 60-85, 65-80, 70-75 wt. % of the fatty acids at the 2-position of the triglyceride of the H-type.

In triglyceride mixture between 50-90, 55-85, 60-80,. 65-75% of the fatty acids at the 2-position of the triglyceride can be of the C18:0-type.

The triglyceride mixture can contain less than 2, 3, 4, 5, 6, 7, 8, 9, 10% of the fatty acids at the 2-position of the triglyceride of the C16:0 type.

In the triglyceride mixture between 2-10, 3-9, 4-8, 5-7% of the saturated fatty acid at the 2-position of the triglyceride can be of the C16:0 type.

The triglyceride mixture can contain more than 50, 60, 70, 75, 80, 85, 90% of the fatty acids at the 2-position of the triglyceride of the C16:0 type

In the method of the present invention. the trialvceride mixture can have an SFC profile of

| | | preferably |
|---|---|---|
| Temperature | % | % |
| 5° C. | >70 | >75 |
| 10° C. | 65-77 | 68-75 |
| 20° C. | 45-62 | 55-60 |
| 30° C. | 30-65 | 35-55 |
| 35° C. | 25-50 | 30-45 |

In the method of the present invention, the triglyceride mixture can contain less than 35, 30, 20, 10, 5 wt. % of unsaturated fatty acids

The triglyceride mixture can contain less than 5 wt. % of trans fatty acids, more preferably less than 1 wt. %, 0.5, 0.1 wt. % or even 0 wt. % (non-detectable using analysis methods common in the art).

The invention further relates to the use of the triglyceride mixture of the present invention in the preparation of further structuring (hard stock) fats, for instance by blending with other fats and/or oils or by enzymatic or catalytic interesterification with other fats and/or oils. The high levels of saturation provided in the triglyceride mixture of the present invention will aid in providing high levels of saturated fatty acids in in the resulting structuring fats and subsequent applications.

The hard stock proves very suitable for use in fat-continuous spreads. These fat-continuous spreads may have a high level of liquid oil, e.g in a 80 wt % fat spread. In such spread, where the SAFA content may be less than 60 wt %, the total PUFA and MUFA content may be at least 30 wt %, while the product is virtually free from trans-fatty acids, preferably less than 3 wt % of trans-fatty acids.

The present invention further relates to a margarine fat. The margarine fat may comprise a liquid vegetable oil in an amount of 30 to 95 wt % and a hard stock fat according to the invention in an amount of 5 to 70 wt %. The weight percentages are on margarine fat. Suitable liquid vegetable oils for the margarine fat are for example but not limited to the group comprising rapeseed oil, sunflower oil, safflower oil, linseed oil, corn oil, groundnut oil, soybean oil, linola oil and blends thereof. Furthermore the present invention relates to a margarine or fat-continuous spread comprising a margarine fat according to the invention. In another embodiment the present invention also relates to a water-continuous spread comprising a margarine fat according to the invention.

### EXAMPLES

### Characterization of the Reaction Product

The product resulting from the transesterification was analysed using the following analytical methods:

1. FA Analysis For any starting fat or product, the overall fatty acid analysis and the triglyceride composition is determined using conventional procedures in the art such as FAME analysis, GLC/Carbon number method and HPLC silver phase method such as described for example in EP78568, EP652289, JOACS (19914), 68(5), 289-293 and Hammond E. W. J., Chromatography, 203, 397, 1981.

### 2. Solid Fat Content (SFC) Measurements

The solid fat content (SFC) in this description and claims is expressed as N-value, as defined in Fette, Seifen Anstrichmittel 80 180-186 (1978). The stabilization profile applied is heating to a temperature of 80 degrees Celsius, keeping the oil for at least 10 minutes at 60 degrees Celsius or higher, keeping the oil for 1 hour at 0 degrees Celsius and then 30 minutes at the measuring temperature (tempered). An alternative method is described in IUPAC 2.150 method, serial, non-tempered.

### 3. 2-Position Analysis

The method is based on the Joint JOCS/AOCS Official Method Ch 3a-19 (2019).

This method provides a procedure for the determination of the composition of fatty acids which are esterified at the sn-2 position (β (beta) or internal position) of the triacylglycerol molecules in animal and vegetable fats and oils. The method is comprised of the 1(3)-position selective transesterification of the triacylglycerols with ethanol by Candida antarctica lipase to yield 2-monoacylglycerols, followed by the separation of the 2-monoacylglycerols by silica-gel chromatography, and determination of their fatty acid composition by gas chromatography.

### Source Materials

| Material | Origin |
|---|---|
| RBD SFO | Commercial product AH Zaventem |
| | (IV132, 10% SFA) |
| Palmitic acid technical grade | Mosselman Oleochemicals |
| (>98% | |
| Stearic acid, technical grade | Mosselman Oleochemicals |
| (>98% | |
| Lipozyme TLIM | Novozymes (Denmark) |

Parameters of Source Materials

| Parameters | RBD SFO | Palmitic acid | Stearic acid |
|---|---|---|---|
| FAC via GC [%] | | | |
| C14:0 | 0.07 | 0.2 | N.D. |
| C15:0 | N.D. | 0.08 | N.D. |
| C16:0 | 6.3 | 99.8 | 0.2 |
| C16:1 | 0.09 | N.D. | N.D. |
| C17:0 | 0.03 | N.D. | 0.1 |
| C18:0 | 3.4 | N.D. | 99.7 |
| C18:1 | 27.2 | N.D. | N.D. |
| C18:2 | 62.6 | N.D. | N.D. |
| C18:3 | 0.08 | N.D. | N.D. |
| C20:0 | 0.1 | N.D. | N.D. |
| C20:1 | 0.07 | N.D. | N.D. |
| SFA | 9.9 | 100.0 | 100.0 |
| MUFA | 27.4 | 0.0 | 0.0 |
| PUFA | 62.7 | 0.0 | 0.0 |
| IV, calculated [—] | 132.2 | 0.0 | 0.0 |
| % FA @ 2-position | | | |
| C14:0 | NA | | |
| C16:0 | 1 | | |
| C18:0 | 0 | | |
| C18:1 | 23 | | |
| C18:2 | 76 | | |
| C20:0 | NA | | |

N.A.: Not available;
N.D.: Not detectable

### General Set Up One Step Transesterification (Examples 1-4)

RBD sunflower oil (TAG) is combined with a saturated free fatty acid mixture (SFA) in the presence of Novozymes Lipozyme TLIM and kept at 70° C. for 24 hours. Free fatty acids are stripped (removed by high temperature/low pressure (vacuum) steam distillation) and the resulting product is analyzed.

### General Set Up Two Step Transesterification (Example 1 and 2)

The stripped reaction product of the one step transesterification is used as TAG combined with a saturated free fatty acid mixture SFA in the presence of Novozymes Lipozyme TLIM and kept at 70° C. for 24 hours. Free fatty acids are stripped (removed by high temperature/low pressure (vacuum) steam distillation) and the resulting product is analyzed.

### Experimental Data

| Parameters | Ex. 1 | | Ex. 2 | | Ex. 3 | Ex. 4 |
|---|---|---|---|---|---|---|
| scale | Lab | | Lab | | Lab | pilot |
| | scale | | scale | | scale | |
| ETE/EIE | Step 1 | Step 2 | Step 1 | Step 2 | | |
| TAG/FA (w/w) | 56.4/43.6 | 68.4/31.6 | 45/55 | 60/40 | 30/70 | 30/70 |
| TAG fraction | SFO | Ex 1 | SFO | Ex 2 | SFO | SFO |
| | | Step 1 | | Step 1 | | |
| C16:0/C18:0 (w:w) | 6/94 | 6/94 | 6/94 | 6/94 | 6/94 | 6/94 |
| TLIM [%]¹ | 4.0 | 5.2 | 8.0 | 8.0 | 8.0 | 8.0 |
| Reaction T [° C.] | 70 | 70 | 70 | 70 | 70 | 70 |
| Reaction t [h] | 24 | 24 | 24 | 24 | 24 | 24 |
| Stripping | | | | | | |
| FFA removal [%] | >99 | >99 | >99 | >99 | >99 | >99 |
| FAC via GC [%] | | | | | | |
| C14:0 | 0.05 | 0.02 | 0.04 | N.D. | 0.04 | 0.06 |
| C16:0 | 5.6 | 5.4 | 6.0 | 6.0 | 6.1 | 6.3 |
| C16:1 | 0.05 | 0.04 | 0.04 | N.D. | 0.03 | 0.03 |
| C17:0 | 0.05 | 0.06 | 0.07 | 0.1 | 0.08 | N.D. |
| C18:0 | 35.3 | 48.2 | 51.6 | 68.1 | 64.2 | 63.7 |
| C18:1 | 17.5 | 13.6 | 12.2 | 7.4 | 8.5 | 9.3 |
| C18:2 | 41.4 | 32.6 | 30.0 | 18.3 | 21.0 | 20.2 |
| C18:3 | 0.05 | 0.03 | 0.02 | N.D. | 0.02 | N.D. |
| C20:0 | 0.08 | 0.06 | 0.1 | N.D. | 0.1 | 0.4 |
| SFA | 41.0 | 53.7 | 57.8 | 74.3 | 70.5 | 70.4 |
| MUFA | 17.5 | 13.6 | 12.2 | 7.4 | 8.5 | 9.4 |
| PUFA | 41.4 | 32.7 | 30.0 | 18.3 | 21.0 | 20.2 |
| Total Trans | ND | <0.5 | ND | ND | ND | <0.5 |
| IV, calculated [—] | 86.9 | 68.3 | 62.5 | 38.1 | 43.7 | 43.1 |
| SFA, theory [%] | 49.2 | 59.9 | 59.5 | 74.7 | 73.0 | 73.0 |
| DIC [%]² | 83.4 | 89.7 | 97.1 | 99.5 | 96.6 | 96.5 |
| TAG via HPLC [%] | | | | | | |
| LLL | 0.9 | 3.2 | 2.7 | 0.7 | 1.0 | 1.5 |
| LLO | 3.6 | 3.9 | 3.3 | 0.9 | 1.2 | 1.7 |
| PLL | 2.8 | 2.0 | 1.9 | 0.8 | 0.9 | 1.3 |
| LOO | 3.3 | 1.7 | 1.4 | 0.4 | 0.5 | 0.8 |
| POL + SLL | 10.8 | 17.7 | 16.0 | 8.9 | 10.0 | 9.2 |
| PLP | 1.6 | 0.6 | 0.6 | 0.4 | 0.4 | 0.6 |
| OOO | 0.8 | 0.1 | 0.08 | 0.03 | 0.1 | 0.2 |
| POO + SLO | 14.8 | 13.7 | 12.2 | 6.6 | 7.6 | 7.3 |
| POP + PLS | 5.9 | 6.2 | 6.5 | 5.8 | 5.9 | 5.5 |
| SOO | 6.8 | 2.8 | 2.3 | 1.4 | 1.6 | 1.7 |
| POS + SLS | 22.4 | 25.5 | 25.7 | 29.4 | 28.5 | 26.6 |
| PPS | 0.7 | 0.4 | 0.5 | 0.7 | 0.7 | 0.8 |
| SOS | 14.6 | 10.0 | 10.0 | 11.2 | 11.2 | 11.4 |
| PSS | 3.8 | 3.3 | 4.6 | 8.2 | 7.2 | 7.6 |
| SSS | 7.3 | 8.9 | 12.1 | 24.6 | 23.2 | 23.9 |
| UUU | 8.7 | 8.9 | 7.5 | 2.0 | 2.8 | 4.2 |
| H | 40.9 | 53.6 | 57.6 | 74.1 | 70.3 | 70.0 |
| M | 0.05 | 0.02 | 0.04 | ND | 0.04 | 0.06 |
| U | 58.9 | 46.2 | 42.2 | 25.7 | 29.5 | 29.5 |
| StUU ⁴ | 35.2 | 36.3 | 32.4 | 17.7 | 20.0 | 19.5 |
| StStU ⁵ | 44.4 | 42.2 | 42.8 | 46.8 | 46.1 | 44.1 |
| StStSt ⁶ | 11.8 | 12.6 | 17.3 | 33.5 | 31.1 | 32.3 |
| StUU + StStU + StStSt | 91.5 | 91.1 | 92.4 | 98 | 97.2 | 95.9 |
| StStU + StStSt | 56.3 | 54.9 | 60.0 | 80.3 | 77.1 | 76.4 |
| StStU + StStSt/(StUU + | 0.615 | 0.602 | 0.649 | 0.819 | 0.793 | 0.797 |
| StStU + StStSt) | | | | | | |
| DIE [%]³ | 98.1 | 58.7 | 82.4 | 80.8 | 80.2 | 83.2 |
| 2-position analysis | | | | | | |
| C14:0 | | | | 0.1 | | |
| C16:0 | | | | 6.9 | | 6.6 |
| C18:0 | | | | 67.0 | | 55.6 |
| C18:1 | | | | 8.2 | | 11.9 |
| C18:2 | | | | 17.4 | | 25.4 |
| C20:0 | | | | 0.3 | | 0.5 |
| 2-H | | | | 74.3 | | 62.7 |
| Carbon number | | | | | | |
| CN50 | | 1.9 | | | | 1.4 |
| CN52 | | 15.0 | | | | 15.7 |
| CN54 | | 74.8 | | | | 72.9 |
| CN56 | | 2.3 | | | | 2.0 |

N.A.: Not available; N.D .: Not detectable.
¹TLIM added after conditioning. concentration based on dry weight;
²DIC = Degree of SFA incorporation = 100 × (actual SFA content/theoretic SFA content); ;
³DIE = Degree of transesterification = 100 × (actual StStSt content/theoretic random StStSt content
⁴ StUU: Tag containing one saturated and two unsaturated FA, any position
⁵ StStU: Tag containing two saturated (St) and one unsaturated (U) FA, any position
⁶ StStSt: Tag containing three saturated FA, any position (PPS + PSS + SSS).

| | | | | | Ex 4. |
|---|---|---|---|---|---|
| | Example 1 | Example 2 | Example 3 | Example 4 | Tempered |
| SFC @ ° C. | % | % | % | % | |
| 0 | 59.9 | 78.8 | 76.9 | 75.6 | |
| 5 | 53.7 | 78.4 | 75.1 | 72.8 | 72.4 |
| 10 | 45.0 | 75.8 | 71.3 | 68.9 | 68.4 |
| 15 | 30.1 | 69.6 | 66.5 | 61.4 | 60.8 |
| 20 | 23.1 | 59.0 | 58.9 | 48.0 | 46.9 |
| 25 | 27.0 | 57.6 | 59.8 | 42.4 | 38.4 |
| 30 | 25.3 | 60.7 | 59.9 | 43.4 | 36.3 |
| 35 | 19.9 | 56.9 | 52.9 | 42.2 | 34.5 |
| 40 | 14.6 | 47.4 | 42.9 | 33.6 | 30.6 |

SFC profile (IUPAC 2.150 serial. non-tempered) of finished. stripped EIE/ETE products and their respective FAD.

### Example 5

### Hard Stock

The fat of example 4 can be interesterified with other oils and fats to produce a hard stock to be applied e.g. in margarine production. Interesterification can be executed by chemical interesterification (CIE) with a catalyst (NaOCH₃) or by enzymatic interesterification (EIE) with lipase for example Lipozyme TLIM (NOVOZYME). The ratio of the fat according to the invention and the other oils and fats is selected to optimize the properties of the resulting hard stock as an ingredient in the final application e.g. a spread

### Chemical Interesterification Procedure (CIE)

The fat of example 4 is blended with other oils and fats in an appropriate ratio to come to the desired hard stock. A stoichiometric amount of NaOH (50% w/w solution in water) is added to ensure FFA of the blend is <0.05% before catalyst dosing. Once the oil is free of FFA, dry it under vacuum to eliminate any residual water (<100 ppm as measured by Karl Fisher titration). When dry, add the catalyst (0.1% w/w) and bring the blend under vacuum (25 mbar). The reaction starts when the color of the blend darkens (red/brownish).Once the reaction is started, allow to react for 30 minutes at 90° C. and 25 mbar. After completion of the reaction, inactivate the catalyst by breaking the vacuum in the reactor and adding citric acid. Dose the acid to ensure 20% molar excess vis-a-vis added catalyst. Citric acid can be dosed as a 20% solution (w/w in water). Let the mixture react for an extra 15 minutes at 90° C. at atmospheric pressure. The CIE hard stock is post-treated: bleached and deodorized. The resulting hard stock is analysed for TAG profile, N-line, 2-position FA analysis.

### Enzymatic Interesterification Procedure (EIE)

The fat of example 4 is blended with other oils and fats in an appropriate ratio to come to the desired hard stock. Add to the blend 8% of Lipozyme TLIM. Allow the mixture to react at 70° C., atmospheric pressure and under agitation to keep the enzyme in suspension for 24 hours. Filter off the enzyme.

The EIE hard stock is post-treated: bleached and deodorized. The resulting hard stock is analysed for TAG profile, N-line, 2-position FA analysis.

### Bleaching

Preheat the oil to 85° C. Dose a stoichiometric amount of citric acid (30% solution) to acidulate soaps and let the mixture react for 15 minutes at atmospheric pressure. Pre-heat the oil to 100° C. under vacuum (50 mbar). Add the bleaching earth (1%-Tonsil 210FF or equivalent activated clay). Agitate the slurry for 30 minutes, at 100° C. and 50 mbar. Filter off the bleaching earth.

### Deodorization

Deodorize the bleached oil until FFA<0.05% (indicative parameters: 240° C.-3 mbar-0.5-1% stripping steam. Cool down to 80° C. and purge with nitrogen and store in hermetically closed recipients.

### Example 6 Margarine Fat

A margarine fat is prepared by blending 95% sunflower oil with 5% of the hardstock fat of example 5.

### Example 7 Margarine Fat

A margarine fat is prepared by blending 30% sunflower oil with 70% of the hardstock fat of example 5.

### Example 8 Spread

A margarine is prepared with the hard stock of example 5 with the following ingredients

| | % | % | |
|---|---|---|---|
| Fatblend | | 79.23 | |
| Rapeseed oil | 16 | | |
| Sunflower oil | 59 | | |
| Hard stock example 5 | 25 | | |
| monoglyceride | | 0.16 | |
| Lecithine | | 0.6 | |
| Minor components (fat) | | 0.01 | |
| Total | | | 80 |
| Water | | 19.9 | |
| Minor components (water) | | 0.1 | |
| Total | | | 20 |

### Example 9 Spread

A margarine is prepared with the hard stock of example 5 with the following ingredients

| | % | % | |
|---|---|---|---|
| Fatblend | | 59.49 | |
| Rapeseed oil | 10 | | |
| Sunflower oil | 77 | | |
| Hard stock example 5 | 13 | | |
| monoglyceride | | 0.3 | |
| Lecithine | | 0.2 | |
| Minor components (fat) | | 0.01 | |
| Total | | | 60 |
| Water | | 39.9 | |
| Minor components (water) | | 0.1 | |
| Total | | | 40 |

### Example 10 Spread

A light margarine is prepared with the hard stock of example 5 with the following ingredients

| | % | % | |
|---|---|---|---|
| Fatblend | | 39.14 | |
| Sunflower oil | 80 | | |
| Hard stock example 5 | 13 | | |
| monoglyceride | | 0.35 | |
| Lecithine | | 0.5 | |
| Minor components (fat) | | 0.01 | |
| Total | | | 40 |
| Water | | 59.9 | |
| Minor components (water) | | 0.1 | |
| Total | | | 60 |

Stability tests are performed for 2-3 weeks cycling at 12 hrs/20 degrees Celsius, 12 hours/5 degrees Celsius. Every week droplet size, spreadability and visual check on emulsion brake down was performed. Mouthfeel is positively tested. The products expressed a good stability, breakdown of emulsion, and no occurrence of graininess or sandiness is observed.

### Embodiments

The invention is now further detailed in a wide variety of embodiments. The embodiments listed herein are a set of permutations of features of the various aspects of the invention and can be combined to further more detailed embodiments of the invention:
1. Method for the preparation of a fat comprising the steps of
   a. providing an oil;
   b. providing a fatty acid mixture having more than 80 wt. % fatty acids of the H type drawn on the fatty acid mixture;
   c. subjecting the oil with the fatty acid mixture to enzymatic transesterification to provide a fat mixture comprising
      i. a triglyceride mixture, which triglyceride mixture contains more than 60% saturated fatty acids drawn on the total amount of fatty acids in the triglyceride mixture, and
      ii. free fatty acids;
   d. removing free fatty acids from the fat mixture
   e. isolating the triglyceride mixture.
2. Method according to embodiment 1, wherein the oil is an edible oil, preferably a vegetable oil.
3. Method according to embodiment 2, wherein the vegetable oil is coconut oil, palm oil, palm kernel oil, rapeseed oil, linseed oil, soy bean oil, maize oil, sunflower oil or mixtures thereof.
4. Method according to embodiment 2 or 3, wherein the vegetable oil is rape seed oil or sunflower oil or mixtures thereof.
5. Method according to any of the previous embodiments, wherein the oil is not palm oil or palm oil-based or palm oil-derived fractions.
6. Method according to any of the previous embodiments, wherein the oil is non-hydrogenated.
7. Method according to any of the previous embodiments, wherein the fatty acid mixture contains more than 85 wt. % of saturated fatty acids.
8. Method according to any of the previous embodiments, wherein the fatty acid mixture contains more than 90 wt. % of saturated fatty acids.
9. Method according to any of the previous embodiments, wherein the fatty acid mixture contains more than 95 wt. % of saturated fatty acids.
10. Method according to any of the previous embodiments, wherein the fatty acid mixture contains more than 98 wt. % of saturated fatty acids.
11. Method according to any of the previous embodiments, wherein the fatty acid mixture contains more than 99 wt. % of saturated fatty acids.

12. Method according to any of the previous embodiments, wherein the fatty acid mixture consists of one fatty acid, preferably selected from the group consisting of stearic acid and palmitic acid or a mixture of stearic and palmitic acid.
13. Method according to any of the previous embodiments, wherein the fatty acid mixture contains less than 20 wt. % of unsaturated fatty acids.
14. Method according to any of the previous embodiments , wherein the fatty acid mixture contains less than 15 wt. % of unsaturated fatty acids.
15. Method according to any of the previous embodiments , wherein the fatty acid mixture contains less than 10 wt. % of unsaturated fatty acids.
16. Method according to any of the previous embodiments , wherein the fatty acid mixture contains less than 5 wt. % of unsaturated fatty acids.
17. Method according to any of the previous embodiments, wherein the fatty acid mixture contains less than 2 wt. % of unsaturated fatty acids.
18. Method according to any of the previous embodiments , wherein the fatty acid mixture contains less than 1 wt. % of unsaturated fatty acids.
19. Method according to any of the previous embodiments, wherein the fatty acid mixture contains more than 85 wt. % of fatty acids of the H type.
20. Method according to any of the previous embodiments, wherein the fatty acid mixture contains more than 90 wt. % of fatty acids of the H type.
21. Method according to any of the previous embodiments, wherein the fatty acid mixture contains more than 95 wt. % of fatty acids of the H type.
22. Method according to any of the previous embodiments, wherein the fatty acid mixture contains more than 98 wt. % of fatty acids of the H type.
23. Method according to any of the previous embodiments, wherein the fatty acid mixture contains more than 99 wt. % of fatty acids of the H type.
24. Method according to any of the previous embodiments, wherein the fatty acid mixture contains more than 50 wt. % of C18:0 fatty acid (stearic acid).
25. Method according to any of the previous embodiments, wherein the fatty acid mixture contains more than 60 wt. % of C18:0 fatty acid (stearic acid).
26. Method according to any of the previous embodiments, wherein the fatty acid mixture contains more than 75 wt. % of C18:0 fatty acid (stearic acid).
27. Method according to any of the previous embodiments, wherein the fatty acid mixture contains more than 80 wt. % of C18:0 fatty acid (stearic acid).
28. Method according to any of the previous embodiments , wherein the fatty acid mixture contains more than 85 wt. % of C18:0 fatty acid (stearic acid).
29. Method according to any of the previous embodiments , wherein the fatty acid mixture contains more than 90 wt. % of C18:0 fatty acid (stearic acid).
30. Method according to any of the previous embodiments , wherein the fatty acid mixture contains more than 95 wt. % of C18:0 fatty acid (stearic acid).
31. Method according to any of the previous embodiments, wherein the fatty acid mixture contains more than 98 wt. % of C18:0 fatty acid (stearic acid).
32. Method according to any of the previous embodiments, wherein the fatty acid mixture contains more than 99 wt. % of C18:0 fatty acid (stearic acid).
33. Method according to any of the previous embodiments, wherein the fatty acid mixture has a saturated C16/C18 ratio of 30/70.
34. Method according to any of the previous embodiments, wherein the fatty acid mixture has a saturated C16/C18 ratio of 20/80.
35. Method according to any of the previous embodiments, wherein the fatty acid mixture has a saturated C16/C18 ratio of 15/85.
36. Method according to any of the previous embodiments, wherein the fatty acid mixture has a saturated C16/C18 ratio of 10/90.
37. Method according to any of the previous embodiments, wherein the fatty acid mixture has a saturated C16/C18 ratio of 5/95.
38. Method according to any of the previous embodiments, wherein the fatty acid mixture has a saturated C16/C18 ratio of 1/99.
39. Method according to any of the previous embodiments, wherein the ratio of the fatty acid mixture to oil is more than 1.5, based on weight equivalents.
40. Method according to any of the previous embodiments, wherein the ratio of the fatty acid mixture to oil is more than 2.5, based on weight equivalents.
41. Method according to any of the previous embodiments, wherein the ratio of the fatty acid mixture to oil is more than 4, based on weight equivalents.
42. Method according to any of the previous embodiments, wherein the ratio of the fatty acid mixture to oil is more than 7.5, based on weight equivalents.
43. Method according to any of the previous embodiments, wherein the fatty acid mixture is a distillate, concentrate or fraction from a vegetable oil or fat.
44. Method according to any of the previous embodiments, wherein the fatty acid mixture is a distillate, concentrate or fraction from a hydrolysed vegetable oil or fat.
45. Method according to any of the previous embodiments, wherein the fatty acid mixture is a distillate, concentrate or fraction from a non-palm vegetable oil or fat.
46. Method according to any of the previous embodiments, wherein the fatty acid mixture is a distillate, concentrate or fraction from a hydrolysed, non-palm vegetable oil or fat.
47. Method according to any of the previous embodiments, wherein the distillate, concentrate or fraction is obtained from coconut oil, palm kernel oil, rapeseed oil, linseed oil, soy bean oil, maize oil, sunflower oil, safou oil, mango butter, phulwara butter, sal butter, bacuri shea butter, kokum butter, allanblackia, algae or mixtures thereof.
48. Method according to any of the previous embodiments, wherein the distillate, concentrate or fraction is obtained from rapeseed oil, linseed oil, soy bean oil, maize oil, sunflower oil or mixtures thereof.
49. Method according to any of the previous embodiments, wherein the enzymatic transesterification uses a lipase.
50. Method according to any of the previous embodiments, wherein the enzymatic transesterification is a random transesterification.
51. Method according to any of the previous embodiments, wherein the transesterification is a one-step transesterification.
52. Method according to any of the previous embodiments, wherein the transesterification is a one-step transesterification using a random lipase.
53. Method according to any of the previous embodiments, wherein the transesterification is a one-step transesterification using a 1-, 3 selective lipase.
54. Method according to any of the previous embodiments, wherein the transesterification is a two-step transesterification using a lipase.
55. Method according to any of the previous embodiments, wherein the transesterification is a two-step transesterification using a lipase in both steps.
56. Method according to any of the previous embodiments, wherein the transesterification is a two-step transesterification using the same lipase in both steps.
57. Method according to any of the previous embodiments, wherein the transesterification is a two-step transesterification using a random lipase in both steps.
58. Method according to any of the previous embodiments, wherein the transesterification is a two-step transesterification using a 1,3-specific lipase in both steps.
59. Method according to any of the previous embodiments, wherein the transesterification is a two-step transesterification using a combination of a random lipase and a 1,3-specific lipase.
60. Method according to any of the previous embodiments, wherein after a first transesterification with a first lipase, free fatty acids are separated from the reaction mixture and the reaction mixture is subsequently contacted with a second fatty acid mixture for a second transesterification with a second lipase.
61. Method according to any of the previous embodiments, wherein the first transesterification and the second transesterification are with the same lipase.
62. Method according to any of the previous embodiments, wherein the first transesterification is with a 1,3-specific lipase and the second transesterification with a random lipase.
63. Method according to any of the previous embodiments, wherein the first transesterification is with a random lipase and the second transesterification with a 1,3-specific lipase.
64. Method according to any of the previous embodiments, wherein the lipase is Lipozyme TLIM.
65. Method according to any of the previous embodiments, wherein the first and second fatty acid mixture have the same composition.
66. Method according to any of the previous embodiments, wherein the first and second fatty acid mixture have a different composition.
67. Method according to any of the previous embodiments, wherein the transesterification is performed in a temperature range of between 50 and 80 degrees Celsius.
68. Method according to any of the previous embodiments, wherein the transesterification is performed in a temperature range of between 60 and 75 degrees Celsius.
69. Method according to any of the previous embodiments, wherein the transesterification is performed in a temperature range of between 68 and 74 degrees Celsius.
70. Method according to any of the previous embodiments, wherein the transesterification is performed at a temperature range of between 69 and 72 degrees Celsius.
71. Method according to any of the previous embodiments, wherein the enzymatic transesterification is continued for more than 12 hours.
72. Method according to any of the previous embodiments, wherein the enzymatic transesterification is continued for more than 18 hours.
73. Method according to any of the previous embodiments, wherein the enzymatic transesterification is continued for more than 24 hours.
74. Method according to any of the previous embodiments, wherein the enzymatic transesterification is continued for more than 36 hours.
75. Method according to any of the previous embodiments, wherein the enzymatic transesterification is continued for more than 48 hours.
76. Method according to any of the previous embodiments, wherein the enzyme is used in an amount ranging from 1-20 wt. % drawn on the amount of oil.
77. Method according to any of the previous embodiments, wherein the enzyme is used in an amount ranging from 2-15 wt. % drawn on the amount of oil
78. Method according to any of the previous embodiments, wherein the enzyme is used in an amount ranging from 3-10 wt. % drawn on the amount of oil
79. Method according to any of the previous embodiments, wherein the degree of transesterification is more than 75%.
80. Method according to any of the previous embodiments, wherein the degree of transesterification is more than 76%.
81. Method according to any of the previous embodiments, wherein the degree of transesterification is more than 77%.
82. Method according to any of the previous embodiments, wherein the degree of transesterification is more than 78%.
83. Method according to any of the previous embodiments, wherein the degree of transesterification is more than 79%.
84. Method according to any of the previous embodiments, wherein the degree of transesterification is more than 80%.
85. Method according to any of the previous embodiments, wherein the degree of transesterification is more than 85%.
86. Method according to any of the previous embodiments, wherein the degree of transesterification is more than 95%.
87. Method according to any of the previous embodiments, wherein the triglyceride mixture comprises more than 65 wt. % of saturated fatty acids drawn on the total amount of fatty acids in the triglyceride mixture.
88. Method according to any of the previous embodiments, wherein the triglyceride mixture comprises more than 70 wt. % of saturated fatty acids drawn on the total amount of fatty acids in the triglyceride mixture.
89. Method according to any of the previous embodiments, wherein the triglyceride mixture comprises more than 75 wt. % of saturated fatty acids drawn on the total amount of fatty acids in the triglyceride mixture.
90. Method according to any of the previous embodiments, wherein the triglyceride mixture comprises more than 80 wt. % of saturated fatty acids drawn on the total amount of fatty acids in the triglyceride mixture.
91. Method according to any of the previous embodiments, wherein the triglyceride mixture comprises more than 85 wt. % of saturated fatty acids drawn on the total amount of fatty acids in the triglyceride mixture.
92. Method according to any of the previous embodiments, wherein the triglyceride mixture comprises more than 90 wt. % of saturated fatty acids drawn on the total amount of fatty acids in the triglyceride mixture.
93. Method according to any of the previous embodiments, wherein the triglyceride mixture comprises more than 95 wt. % of saturated fatty acids drawn on the total amount of fatty acids in the triglyceride mixture.
94. Method according to any of the previous embodiments, wherein the triglyceride mixture comprises more than 60 wt. % of C18:0 drawn on the total amount of fatty acids in the triglyceride mixture.
95. Method according to any of the previous embodiments, wherein the triglyceride mixture comprises more than 65 wt. % of C18:0 drawn on the total amount of fatty acids in the triglyceride mixture.
96. Method according to any of the previous embodiments, wherein the triglyceride mixture comprises more than 70 wt. % of C18:0 drawn on the total amount of fatty acids in the triglyceride mixture.
97. Method according to any of the previous embodiments, wherein the triglyceride mixture comprises more than 75 wt. % of C18:0 drawn on the total amount of fatty acids in the triglyceride mixture.
98. Method according to any of the previous embodiments, wherein the triglyceride mixture comprises more than 80 wt. % of C18:0 drawn on the total amount of fatty acids in the triglyceride mixture.
99. Method according to any of the previous embodiments, wherein the triglyceride mixture comprises triglycerides of the StStSt type in an amount of more than 30% by weight drawn on the total amount of triglycerides in the triglyceride mixture.
100. Method according to any of the previous embodiments, wherein the triglyceride mixture comprises triglycerides of the StStSt type in an amount of more than 31% by weight drawn on the total amount of triglycerides in the triglyceride mixture.
101. Method according to any of the previous embodiments, wherein the triglyceride mixture comprises triglycerides of the StStSt type in an amount of more than 32% by weight drawn on the total amount of triglycerides in the triglyceride mixture.
102. Method according to any of the previous embodiments, wherein the triglyceride mixture comprises triglycerides of the StStSt type in an amount of more than 33% by weight drawn on the total amount of triglycerides in the triglyceride mixture. Method according to any of the previous embodiments, wherein the triglyceride mixture comprises triglycerides of the StStSt type in an amount of more than 34% by weight drawn on the total amount of triglycerides in the triglyceride mixture.
103. Method according to any of the previous embodiments, wherein the triglyceride mixture comprises triglycerides of the StStSt type in an amount of more than 35% by weight drawn on the total amount of triglycerides in the triglyceride mixture.
104. Method according to any of the previous embodiments, wherein the amount of StStSt+StStU+StUU in the triglyceride mixture is more than 90% drawn on the total amount of triglycerides in the triglyceride mixture.
105. Method according to any of the previous embodiments, wherein the amount of StStSt+StStU+StUU in the triglyceride mixture is more than 92% drawn on the total amount of triglycerides in the triglyceride mixture.
106. Method according to any of the previous embodiments, wherein the amount of StStSt+StStU+StUU in the triglyceride mixture is more than 94% drawn on the total amount of triglycerides in the triglyceride mixture.
107. Method according to any of the previous embodiments, wherein the amount of StStSt+StStU+StUU in the triglyceride mixture is more than 95% drawn on the total amount of triglycerides in the triglyceride mixture.
108. Method according to any of the previous embodiments, wherein the amount of StStSt+StStU+StUU in the triglyceride mixture is more than 96% drawn on the total amount of triglycerides in the triglyceride mixture.
109. Method according to any of the previous embodiments, wherein the amount of StStSt+StStU+StUU in the triglyceride mixture is more than 98% drawn on the total amount of triglycerides in the triglyceride mixture.
110. Method according to any of the previous embodiments, wherein the amount of StStSt+StStU+StUU in the triglyceride mixture is more than 99% drawn on the total amount of triglycerides in the triglyceride mixture.
111. Method according to any of the previous embodiments, wherein the ratio (StStSt+StStU)/(StStSt+StStU+StUU) in the triglyceride mixture is more than 0.70.
112. Method according to any of the previous embodiments, wherein the ratio (StStSt+StStU)/(StStSt+StStU+StUU) in the triglyceride mixture is more than 0.75.
113. Method according to any of the previous embodiments, wherein the ratio (StStSt+StStU)/(StStSt+StStU+StUU) in the triglyceride mixture is more than 0.80.
114. Method according to any of the previous embodiments, wherein the ratio (StStSt+StStU)/(StStSt+StStU+StUU) in the triglyceride mixture is more than 0.85.
115. Method according to any of the previous embodiments, wherein the ratio (StStSt+StStU)/(StStSt+StStU+StUU) in the triglyceride mixture is more than 0.90.
116. Method according to any of the previous embodiments, wherein the ratio (StStSt+StStU)/(StStSt+StStU+StUU) in the triglyceride mixture is more than 0.95.
117. Method according to any of the previous embodiments, wherein the ratio (StStSt+StStU)/(StStSt+StStU+StUU) in the triglyceride mixture is more than 0.98.
118. Method according to any of the previous embodiments, wherein in the triglyceride mixture more than 50% of the fatty acids at the 2-position of the triglyceride is of the H-type.
119. Method according to any of the previous embodiments, wherein in the triglyceride mixture more than 55% of the fatty acids at the 2-position of the triglyceride is of the H-type
120. Method according to any of the previous embodiments, wherein in the triglyceride mixture more than 60% of the fatty acids at the 2-position of the triglyceride is of the H-type.
121. Method according to any of the previous embodiments, wherein in the triglyceride mixture more than 65% of the fatty acids at the 2-position of the triglyceride is of the H-type.
122. Method according to any of the previous embodiments, wherein in the triglyceride mixture more than 70% of the fatty acids at the 2-position of the triglyceride is of the H-type.
123. Method according to any of the previous embodiments, wherein in the triglyceride mixture more than 75% of the fatty acids at the 2-position of the triglyceride is of the H-type.
124. Method according to any of the previous embodiments, wherein in the triglyceride mixture more than 80% of the fatty acids at the 2-position of the triglyceride is of the H-type.
125. Method according to any of the previous embodiments, wherein in the triglyceride mixture more than 85% of the fatty acids at the 2-position of the triglyceride is of the H-type.
126. Method according to any of the previous embodiments, wherein in the triglyceride mixture more than 90% of the fatty acids at the 2-position of the triglyceride is of the H-type.
127. Method according to any of the previous embodiments, wherein in the triglyceride mixture more than 95% of the fatty acids at the 2-position of the triglyceride is of the H-type.
128. Method according to any of the previous embodiments, wherein in the triglyceride mixture less than 2% of the fatty acids at the 2-position of the triglyceride is of the C16:0 type.
129. Method according to any of the previous embodiments, wherein in the triglyceride mixture less than 3% of the fatty acids at the 2-position of the triglyceride is of the C16:0 type.
130. Method according to any of the previous embodiments, wherein in the triglyceride mixture less than 4% of the fatty acids at the 2-position of the triglyceride is of the C16:0 type.
131. Method according to any of the previous embodiments, wherein in the triglyceride mixture less than 5% of the fatty acids at the 2-position of the triglyceride is of the C16:0 type.
132. Method according to any of the previous embodiments, wherein in the triglyceride mixture less than 6% of the fatty acids at the 2-position of the triglyceride is of the C16:0 type.
133. Method according to any of the previous embodiments, wherein in the triglyceride mixture less than 7% of the fatty acids at the 2-position of the triglyceride is of the C16:0 type.
134. Method according to any of the previous embodiments, wherein in the triglyceride mixture less than 8% of the fatty acids at the 2-position of the triglyceride is of the C16:0 type.
135. Method according to any of the previous embodiments, wherein in the triglyceride mixture less than 9% of the fatty acids at the 2-position of the triglyceride is of the C16:0 type.
136. Method according to any of the previous embodiments, wherein in the triglyceride mixture less than 10% of the fatty acids at the 2-position of the triglyceride is of the C16:0 type.
137. Method according to any of the previous embodiments, wherein in the triglyceride mixture more than 50% of the fatty acids at the 2-position of the triglyceride is of the C18:0-type.
138. Method according to any of the previous embodiments, wherein in the triglyceride mixture more than 60% of the fatty acids at the 2-position of the triglyceride is of the C18:0-type.
139. Method according to any of the previous embodiments, wherein in the triglyceride mixture more than 70% of the fatty acids at the 2-position of the triglyceride is of the C18:0-type.
140. Method according to any of the previous embodiments, wherein in the triglyceride mixture more than 75% of the fatty acids at the 2-position of the triglyceride is of the C18:0-type.
141. Method according to any of the previous embodiments, wherein in the triglyceride mixture more than 80% of the fatty acids at the 2-position of the triglyceride is of the C18:0-type.
142. Method according to any of the previous embodiments, wherein in the triglyceride mixture more than 85% of the fatty acids at the 2-position of the triglyceride is of the C18:0-type.
143. Method according to any of the previous embodiments, wherein in the triglyceride mixture more than 90% of the fatty acids at the 2-position of the triglyceride is of the C18:0-type.
144. Method according to any of the previous embodiments, wherein the triglyceride mixture comprises between 65-95 wt. % of saturated fatty acids drawn on the total amount of fatty acids in the triglyceride mixture
145. Method according to any of the previous embodiments, wherein the triglyceride mixture comprises between 66-90 wt. % of saturated fatty acids drawn on the total amount of fatty acids in the triglyceride mixture
146. Method according to any of the previous embodiments, wherein the triglyceride mixture comprises between 67-85 wt. % of saturated fatty acids drawn on the total amount of fatty acids in the triglyceride mixture
147. Method according to any of the previous embodiments, wherein the triglyceride mixture comprises between 68-80 wt. % of saturated fatty acids drawn on the total amount of fatty acids in the triglyceride mixture
148. Method according to any of the previous embodiments, wherein the triglyceride mixture comprises between 69-75 wt. % of saturated fatty acids drawn on the total amount of fatty acids in the triglyceride mixture
149. Method according to any of the previous embodiments, wherein the triglyceride mixture comprises between 60-80, 61 wt. % of C18:0 drawn on the total amount of fatty acids in the triglyceride mixture.
150. Method according to any of the previous embodiments, wherein the triglyceride mixture comprises between, 61-75 wt. % of C18:0 drawn on the total amount of fatty acids in the triglyceride mixture.
151. Method according to any of the previous embodiments, wherein the triglyceride mixture comprises between 62-70 wt. % of C18:0 drawn on the total amount of fatty acids in the triglyceride mixture.
152. Method according to any of the previous embodiments, wherein the triglyceride mixture comprises triglycerides of the StStSt type in an amount between 30-35% by weight drawn on the total amount of triglycerides in the triglyceride mixture.
153. Method according to any of the previous embodiments, wherein the triglyceride mixture comprises triglycerides of the StStSt type in an amount between 31-34% by weight drawn on the total amount of triglycerides in the triglyceride mixture.
154. Method according to any of the previous embodiments, wherein the triglyceride mixture comprises triglycerides of the StStSt type in an amount between 32-33% by weight drawn on the total amount of triglycerides in the triglyceride mixture.
155. Method according to any of the previous embodiments, wherein the amount of StStSt+StStU+StUU in the triglyceride mixture is between 90-99, % drawn on the total amount of triglycerides in the triglyceride mixture.
156. Method according to any of the previous embodiments, wherein the amount of StStSt+StStU+StUU in the triglyceride mixture is between 91-98, % drawn on the total amount of triglycerides in the triglyceride mixture.
157. Method according to any of the previous embodiments, wherein the amount of StStSt+StStU+StUU in the triglyceride mixture is between, 92-97% drawn on the total amount of triglycerides in the triglyceride mixture.
158. Method according to any of the previous embodiments, wherein the amount of StStSt+StStU+StUU in the triglyceride mixture is between 93-96% drawn on the total amount of triglycerides in the triglyceride mixture.
159. Method according to any of the previous embodiments, wherein the ratio (StStSt+StStU)/(StStSt+StStU+StUU) in the triglyceride mixture is between 0.70.-0.98.
160. Method according to any of the previous embodiments, wherein the ratio (StStSt+StStU)/(StStSt+StStU+StUU) in the triglyceride mixture is between, 0.75-0.95.
161. Method according to any of the previous embodiments, wherein the ratio (StStSt+StStU)/(StStSt+StStU+StUU) in the triglyceride mixture is between 0.80-0.90.
162. Method according to any of the previous embodiments, wherein in the triglyceride mixture between 50-95% of the fatty acids at the 2-position of the triglyceride is of the H-type.
163. Method according to any of the previous embodiments, wherein in the triglyceride mixture between 55-90%of the saturated fatty acids at the 2-position of the triglyceride is of the H-type.
164. Method according to any of the previous embodiments, wherein in the triglyceride mixture between 60-85% of the fatty acids at the 2-position of the triglyceride is of the H-type.
165. Method according to any of the previous embodiments, wherein in the triglyceride mixture between, 65-80% of the fatty acids at the 2-position of the triglyceride is of the H-type.
166. Method according to any of the previous embodiments, wherein in the triglyceride mixture between 2-10% of the saturated fatty acid at the 2-position of the triglyceride is of the C16:0 type.
167. Method according to any of the previous embodiments, wherein in the triglyceride mixture between 3-9% of the saturated fatty acid at the 2-position of the triglyceride is of the C16:0 type.
168. Method according to any of the previous embodiments, wherein in the triglyceride mixture between 4-8% of the saturated fatty acid at the 2-position of the triglyceride is of the C16:0 type.
169. Method according to any of the previous embodiments, wherein in the triglyceride mixture between 5-7% of the saturated fatty acid at the 2-position of the triglyceride is of the C16:0 type.
170. Method according to any of the previous embodiments, wherein in the triglyceride mixture between 50-90% of the fatty acids at the 2-position of the triglyceride is of the C18:0-type.
171. Method according to any of the previous embodiments, wherein in the triglyceride mixture between 55-85% of the fatty acids at the 2-position of the triglyceride is of the C18:0-type.
172. Method according to any of the previous embodiments, wherein in the triglyceride mixture between 60-80% of the fatty acids at the 2-position of the triglyceride is of the C18:0-type.
173. Method according to any of the previous embodiments, wherein in the triglyceride mixture between 65-75% of the fatty acids at the 2-position of the triglyceride is of the C18:0-type.
174. Method according to any of the previous embodiments, wherein in the triglyceride mixture has an SFC profile of

| Temperature | % |
|---|---|
| 5° C. | >70 |
| 10° C. | 65-77 |
| 20° C. | 45-62 |
| 30° C. | 30-65 |
| 35° C. | 25-50 |

175. Method according to any of the previous embodiments, wherein in the triglyceride mixture has an SFC profile of

| Temperature | % |
|---|---|
| 5° C. | >75 |
| 10° C. | 68-75 |
| 20° C. | 55-70 |
| 30° C. | 35-55 |
| 35° C. | 30-45 |

176. Method according to any of the previous embodiments, wherein the triglyceride mixture contains less than 5% trans fatty acids.
177. Method according to any of the previous embodiments, wherein the triglyceride mixture contains less than 1% trans fatty acids.
178. Method according to any of the previous embodiments, wherein the triglyceride mixture contains less than 0.5% trans fatty acids
179. Method according to any of the previous embodiments, wherein the triglyceride mixture contains less than 0.1% trans fatty acids.
180. Method according to any of the previous embodiments, wherein the triglyceride mixture contains less than 35% unsaturated fatty acids.
181. Method according to any of the previous embodiments, wherein the triglyceride mixture contains less than 30% unsaturated fatty acids.
182. Method according to any of the previous embodiments, wherein the triglyceride mixture contains less than 20% unsaturated fatty acids.
183. Method according to any of the previous embodiments, wherein the triglyceride mixture contains less than 10% unsaturated fatty acids.
184. Method according to any of the previous embodiments, wherein the triglyceride mixture contains less than 5% unsaturated fatty acids.
185. Triglyceride mixture obtainable by the method of any of the embodiments 1-184.
186. Triglyceride mixture according to embodiment 185, wherein the triglyceride mixture comprises more than 65 wt. % of saturated fatty acids drawn on the total amount of fatty acids in the triglyceride mixture.
187. Triglyceride mixture according to any of the previous embodiments, wherein the triglyceride mixture comprises more than 70 wt. % of saturated fatty acids drawn on the total amount of fatty acids in the triglyceride mixture.
188. Triglyceride mixture according to any of the previous embodiments, wherein the triglyceride mixture comprises more than 75 wt. % of saturated fatty acids drawn on the total amount of fatty acids in the triglyceride mixture.
189. Triglyceride mixture according to any of the previous embodiments, wherein the triglyceride mixture comprises more than 80 wt. % of saturated fatty acids drawn on the total amount of fatty acids in the triglyceride mixture.
190. Triglyceride mixture according to any of the previous embodiments, wherein the triglyceride mixture comprises more than 85 wt. % of saturated fatty acids drawn on the total amount of fatty acids in the triglyceride mixture.
191. Triglyceride mixture according to any of the previous embodiments, wherein the triglyceride mixture comprises more than 90 wt. % of saturated fatty acids drawn on the total amount of fatty acids in the triglyceride mixture.
192. Triglyceride mixture according to any of the previous embodiments, wherein the triglyceride mixture comprises more than 95 wt. % of saturated fatty acids drawn on the total amount of fatty acids in the triglyceride mixture.
193. Triglyceride mixture according to any of the previous embodiments, wherein the triglyceride mixture comprises more than 60 wt. % of C18:0 drawn on the total amount of fatty acids in the triglyceride mixture.
194. Triglyceride mixture according to any of the previous embodiments, wherein the triglyceride mixture comprises more than 65 wt. % of C18:0 drawn on the total amount of fatty acids in the triglyceride mixture.
195. Triglyceride mixture according to any of the previous embodiments, wherein the triglyceride mixture comprises more than 70 wt. % of C18:0 drawn on the total amount of fatty acids in the triglyceride mixture.
196. Triglyceride mixture according to any of the previous embodiments, wherein the triglyceride mixture comprises more than 75 wt. % of C18:0 drawn on the total amount of fatty acids in the triglyceride mixture.
197. Triglyceride mixture according to any of the previous embodiments, wherein the triglyceride mixture comprises more than 80 wt. % of C18:0 drawn on the total amount of fatty acids in the triglyceride mixture.
198. Triglyceride mixture according to any of the previous embodiments, wherein the triglyceride mixture comprises triglycerides of the StStSt type in an amount of more than 30% by weight drawn on the total amount of triglycerides in the triglyceride mixture.
199. Triglyceride mixture according to any of the previous embodiments, wherein the triglyceride mixture comprises triglycerides of the StStSt type in an amount of more than 31% by weight drawn on the total amount of triglycerides in the triglyceride mixture.
200. Triglyceride mixture according to any of the previous embodiments, wherein the triglyceride mixture comprises triglycerides of the StStSt type in an amount of more than 32% by weight drawn on the total amount of triglycerides in the triglyceride mixture.
201. Triglyceride mixture according to any of the previous embodiments, wherein the triglyceride mixture comprises triglycerides of the StStSt type in an amount of more than 33% by weight drawn on the total amount of triglycerides in the triglyceride mixture. Triglyceride mixture according to any of the previous embodiments, wherein the triglyceride mixture comprises triglycerides of the StStSt type in an amount of more than 34% by weight drawn on the total amount of triglycerides in the triglyceride mixture.
202. Triglyceride mixture according to any of the previous embodiments, wherein the triglyceride mixture comprises triglycerides of the StStSt type in an amount of more than 35% by weight drawn on the total amount of triglycerides in the triglyceride mixture.
203. Triglyceride mixture according to any of the previous embodiments, wherein the amount of StStSt+StStU+StUU in the triglyceride mixture is more than 90% drawn on the total amount of triglycerides in the triglyceride mixture.
204. Triglyceride mixture according to any of the previous embodiments, wherein the amount of StStSt+StStU+StUU in the triglyceride mixture is more than 92% drawn on the total amount of triglycerides in the triglyceride mixture.
205. Triglyceride mixture according to any of the previous embodiments, wherein the amount of StStSt+StStU+StUU in the triglyceride mixture is more than 94% drawn on the total amount of triglycerides in the triglyceride mixture.
206. Triglyceride mixture according to any of the previous embodiments, wherein the amount of StStSt+StStU+StUU in the triglyceride mixture is more than 95% drawn on the total amount of triglycerides in the triglyceride mixture.
207. Triglyceride mixture according to any of the previous embodiments, wherein the amount of StStSt+StStU+StUU in the triglyceride mixture is more than 96% drawn on the total amount of triglycerides in the triglyceride mixture.
208. Triglyceride mixture according to any of the previous embodiments, wherein the amount of StStSt+StStU+StUU in the triglyceride mixture is more than 98% drawn on the total amount of triglycerides in the triglyceride mixture.
209. Triglyceride mixture according to any of the previous embodiments, wherein the amount of StStSt+StStU+StUU in the triglyceride mixture is more than 99% drawn on the total amount of triglycerides in the triglyceride mixture.
210. Triglyceride mixture according to any of the previous embodiments, wherein the ratio (StStSt+StStU)/(StStSt+StStU+StUU) in the triglyceride mixture is more than 0.70.
211. Triglyceride mixture according to any of the previous embodiments, wherein the ratio (StStSt+StStU)/(StStSt+StStU+StUU) in the triglyceride mixture is more than 0.75.
212. Triglyceride mixture according to any of the previous embodiments, wherein the ratio (StStSt+StStU)/(StStSt+StStU+StUU) in the triglyceride mixture is more than 0.80.
213. Triglyceride mixture according to any of the previous embodiments, wherein the ratio (StStSt+StStU)/(StStSt+StStU+StUU) in the triglyceride mixture is more than 0.85.
214. Triglyceride mixture according to any of the previous embodiments, wherein the ratio (StStSt+StStU)/(StStSt+StStU+StUU) in the triglyceride mixture is more than 0.90.
215. Triglyceride mixture according to any of the previous embodiments, wherein the ratio (StStSt+StStU)/(StStSt+StStU+StUU) in the triglyceride mixture is more than 0.95.
216. Triglyceride mixture according to any of the previous embodiments, wherein the ratio (StStSt+StStU)/(StStSt+StStU+StUU) in the triglyceride mixture is more than 0.98.
217. Triglyceride mixture according to any of the previous embodiments, wherein in the triglyceride mixture more than 50% of the fatty acids at the 2-position of the triglyceride is of the H-type.
218. Triglyceride mixture according to any of the previous embodiments, wherein in the triglyceride mixture more than 55% of the fatty acids at the 2-position of the triglyceride is of the H-type
219. Triglyceride mixture according to any of the previous embodiments, wherein in the triglyceride mixture more than 60% of the fatty acids at the 2-position of the triglyceride is of the H-type.
220. Triglyceride mixture according to any of the previous embodiments, wherein in the triglyceride mixture more than 65% of the fatty acids at the 2-position of the triglyceride is of the H-type.
221. Triglyceride mixture according to any of the previous embodiments, wherein in the triglyceride mixture more than 70% of the fatty acids at the 2-position of the triglyceride is of the H-type.
222. Triglyceride mixture according to any of the previous embodiments, wherein in the triglyceride mixture more than 75% of the fatty acids at the 2-position of the triglyceride is of the H-type.
223. Triglyceride mixture according to any of the previous embodiments, wherein in the triglyceride mixture more than 80% of the fatty acids at the 2-position of the triglyceride is of the H-type.
224. Triglyceride mixture according to any of the previous embodiments, wherein in the triglyceride mixture more than 85% of the fatty acids at the 2-position of the triglyceride is of the H-type.
225. Triglyceride mixture according to any of the previous embodiments, wherein in the triglyceride mixture more than 90% of the fatty acids at the 2-position of the triglyceride is of the H-type.
226. Triglyceride mixture according to any of the previous embodiments, wherein in the triglyceride mixture more than 95% of the fatty acids at the 2-position of the triglyceride is of the H-type.
227. Triglyceride mixture according to any of the previous embodiments, wherein in the triglyceride mixture less than 2% of the fatty acids at the 2-position of the triglyceride is of the C16:0 type.
228. Triglyceride mixture according to any of the previous embodiments, wherein in the triglyceride mixture less than 3% of the fatty acids at the 2-position of the triglyceride is of the C16:0 type.
229. Triglyceride mixture according to any of the previous embodiments, wherein in the triglyceride mixture less than 4% of the fatty acids at the 2-position of the triglyceride is of the C16:0 type.
230. Triglyceride mixture according to any of the previous embodiments, wherein in the triglyceride mixture less than 5% of the fatty acids at the 2-position of the triglyceride is of the C16:0 type.
231. Triglyceride mixture according to any of the previous embodiments, wherein in the triglyceride mixture less than 6% of the fatty acids at the 2-position of the triglyceride is of the C16:0 type.
232. Triglyceride mixture according to any of the previous embodiments, wherein in the triglyceride mixture less than 7% of the fatty acids at the 2-position of the triglyceride is of the C16:0 type.
233. Triglyceride mixture according to any of the previous embodiments, wherein in the triglyceride mixture less than 8% of the fatty acids at the 2-position of the triglyceride is of the C16:0 type.
234. Triglyceride mixture according to any of the previous embodiments, wherein in the triglyceride mixture less than 9% of the fatty acids at the 2-position of the triglyceride is of the C16:0 type.
235. Triglyceride mixture according to any of the previous embodiments, wherein in the triglyceride mixture less than 10% of the fatty acids at the 2-position of the triglyceride is of the C16:0 type.
236. Triglyceride mixture according to any of the previous embodiments, wherein in the triglyceride mixture more than 50% of the fatty acids at the 2-position of the triglyceride is of the C18:0-type.
237. Triglyceride mixture according to any of the previous embodiments, wherein in the triglyceride mixture more than 60% of the fatty acids at the 2-position of the triglyceride is of the C18:0-type.
238. Triglyceride mixture according to any of the previous embodiments, wherein in the triglyceride mixture more than 70% of the fatty acids at the 2-position of the triglyceride is of the C18:0-type.
239. Triglyceride mixture according to any of the previous embodiments, wherein in the triglyceride mixture more than 75% of the fatty acids at the 2-position of the triglyceride is of the C18:0-type.
240. Triglyceride mixture according to any of the previous embodiments, wherein in the triglyceride mixture more than 80% of the fatty acids at the 2-position of the triglyceride is of the C18:0-type.
241. Triglyceride mixture according to any of the previous embodiments, wherein in the triglyceride mixture more than 85% of the fatty acids at the 2-position of the triglyceride is of the C18:0-type.
242. Triglyceride mixture according to any of the previous embodiments, wherein in the triglyceride mixture more than 90% of the fatty acids at the 2-position of the triglyceride is of the C18:0-type.
243. Triglyceride mixture according to any of the previous embodiments, wherein the triglyceride mixture comprises between 65-95 wt. % of saturated fatty acids drawn on the total amount of fatty acids in the triglyceride mixture
244. Triglyceride mixture according to any of the previous embodiments, wherein the triglyceride mixture comprises between 66-90 wt. % of saturated fatty acids drawn on the total amount of fatty acids in the triglyceride mixture
245. Triglyceride mixture according to any of the previous embodiments, wherein the triglyceride mixture comprises between 67-85 wt. % of saturated fatty acids drawn on the total amount of fatty acids in the triglyceride mixture
246. Triglyceride mixture according to any of the previous embodiments, wherein the triglyceride mixture comprises between 68-80 wt. % of saturated fatty acids drawn on the total amount of fatty acids in the triglyceride mixture
247. Triglyceride mixture according to any of the previous embodiments, wherein the triglyceride mixture comprises between 69-75 wt. % of saturated fatty acids drawn on the total amount of fatty acids in the triglyceride mixture
248. Triglyceride mixture according to any of the previous embodiments, wherein the triglyceride mixture comprises between 60-80, 61 wt. % of C18:0 drawn on the total amount of fatty acids in the triglyceride mixture.
249. Triglyceride mixture according to any of the previous embodiments, wherein the triglyceride mixture comprises between, 61-75 wt. % of C18:0 drawn on the total amount of fatty acids in the triglyceride mixture.
250. Triglyceride mixture according to any of the previous embodiments, wherein the triglyceride mixture comprises between 62-70 wt. % of C18:0 drawn on the total amount of fatty acids in the triglyceride mixture.
251. Triglyceride mixture according to any of the previous embodiments, wherein the triglyceride mixture comprises triglycerides of the StStSt type in an amount between 30-35% by weight drawn on the total amount of triglycerides in the triglyceride mixture.
252. Triglyceride mixture according to any of the previous embodiments, wherein the triglyceride mixture comprises triglycerides of the StStSt type in an amount between 31-34% by weight drawn on the total amount of triglycerides in the triglyceride mixture.
253. Triglyceride mixture according to any of the previous embodiments, wherein the triglyceride mixture comprises triglycerides of the StStSt type in an amount between 32-33% by weight drawn on the total amount of triglycerides in the triglyceride mixture.
254. Triglyceride mixture according to any of the previous embodiments, wherein the amount of StStSt+StStU+StUU in the triglyceride mixture is between 90-99, % drawn on the total amount of triglycerides in the triglyceride mixture.
255. Triglyceride mixture according to any of the previous embodiments, wherein the amount of StStSt+StStU+StUU in the triglyceride mixture is between 91-98, % drawn on the total amount of triglycerides in the triglyceride mixture.
256. Triglyceride mixture according to any of the previous embodiments, wherein the amount of StStSt+StStU+StUU in the triglyceride mixture is between, 92-97% drawn on the total amount of triglycerides in the triglyceride mixture.
257. Triglyceride mixture according to any of the previous embodiments, wherein the amount of StStSt+StStU+StUU in the triglyceride mixture is between 93-96% drawn on the total amount of triglycerides in the triglyceride mixture.
258. Triglyceride mixture according to any of the previous embodiments, wherein the ratio (StStSt+StStU)/(StStSt+StStU+StUU) in the triglyceride mixture is between 0.70.- 0.98.
259. Triglyceride mixture according to any of the previous embodiments, wherein the ratio (StStSt+StStU)/(StStSt+StStU+StUU) in the triglyceride mixture is between, 0.75-0.95.
260. Triglyceride mixture according to any of the previous embodiments, wherein the ratio (StStSt+StStU)/(StStSt+StStU+StUU) in the triglyceride mixture is between 0.80-0.90.
261. Triglyceride mixture according to any of the previous embodiments, wherein in the triglyceride mixture between 50-95% of the fatty acids at the 2-position of the triglyceride is of the H-type.
262. Triglyceride mixture according to any of the previous embodiments, wherein in the triglyceride mixture between 55-90%of the saturated fatty acids at the 2-position of the triglyceride is of the H-type.
263. Triglyceride mixture according to any of the previous embodiments, wherein in the triglyceride mixture between 60-85% of the fatty acids at the 2-position of the triglyceride is of the H-type.
264. Triglyceride mixture according to any of the previous embodiments, wherein in the triglyceride mixture between, 65-80% of the fatty acids at the 2-position of the triglyceride is of the H-type.
265. Triglyceride mixture according to any of the previous embodiments, wherein in the triglyceride mixture between 2-10% of the saturated fatty acid at the 2-position of the triglyceride is of the C16:0 type.
266. Triglyceride mixture according to any of the previous embodiments, wherein in the triglyceride mixture between 3-9% of the saturated fatty acid at the 2-position of the triglyceride is of the C16:0 type.
267. Triglyceride mixture according to any of the previous embodiments, wherein in the triglyceride mixture between 4-8% of the saturated fatty acid at the 2-position of the triglyceride is of the C16:0 type.
268. Triglyceride mixture according to any of the previous embodiments, wherein in the triglyceride mixture between 5-7% of the saturated fatty acid at the 2-position of the triglyceride is of the C16:0 type.
269. Triglyceride mixture according to any of the previous embodiments, wherein in the triglyceride mixture between 50-90% of the fatty acids at the 2-position of the triglyceride is of the C18:0-type.
270. Triglyceride mixture according to any of the previous embodiments, wherein in the triglyceride mixture between 55-85% of the fatty acids at the 2-position of the triglyceride is of the C18:0-type.
271. Triglyceride mixture according to any of the previous embodiments, wherein in the triglyceride mixture between 60-80% of the fatty acids at the 2-position of the triglyceride is of the C18:0-type.
272. Triglyceride mixture according to any of the previous embodiments, wherein in the triglyceride mixture between 65-75% of the fatty acids at the 2-position of the triglyceride is of the C18:0-type.
273. Triglyceride mixture according to any of the previous embodiments, wherein in the triglyceride mixture has an SFC profile of

| Temperature | % |
|---|---|
| 5° C. | >70 |
| 10° C. | 65-77 |
| 20° C. | 45-62 |
| 30° C. | 30-65 |
| 35° C. | 25-50 |

274. Triglyceride mixture according to any of the previous embodiments, wherein in the triglyceride mixture has an SFC profile of

| Temperature | % |
|---|---|
| 5° C. | >75 |
| 10° C. | 68-75 |
| 20° C. | 55-70 |
| 30° C. | 35-55 |
| 35° C. | 30-45 |

275. Triglyceride mixture according to any of the previous embodiments, wherein the triglyceride mixture contains less than 5% trans fatty acids.
276. Triglyceride mixture according to any of the previous embodiments, wherein the triglyceride mixture contains less than 1% trans fatty acids.
277. Triglyceride mixture according to any of the previous embodiments, wherein the triglyceride mixture contains less than 0.5% trans fatty acids.
278. Triglyceride mixture according to any of the previous embodiments, wherein the triglyceride mixture contains less than 0.1% trans fatty acids.
279. Triglyceride mixture according to any of the previous embodiments, wherein the triglyceride mixture contains less than 35% unsaturated fatty acids.
280. Triglyceride mixture according to any of the previous embodiments, wherein the triglyceride mixture contains less than 30% unsaturated fatty acids.
281. Triglyceride mixture according to any of the previous embodiments, wherein the triglyceride mixture contains less than 20% unsaturated fatty acids.
282. Triglyceride mixture according to any of the previous embodiments, wherein the triglyceride mixture contains less than 10% unsaturated fatty acids.
283. Triglyceride mixture according to any of the previous embodiments, wherein the triglyceride mixture contains less than 5% unsaturated fatty acids.
284. Use of the triglyceride mixture as defined in the above embodiments in the preparation of further structuring fats, for instance by blending with other fats and/or oils or by interesterification with other fats and or oils.

1. Method for the preparation of a fat comprising the steps of
a. providing an oil;
b. providing a fatty acid mixture having more than 80 wt. % fatty acids of the H type drawn on the fatty acid mixture;
c. subjecting the oil with the fatty acid mixture to enzymatic transesterification to provide a fat mixture comprising
i. a triglyceride mixture, which triglyceride mixture contains more than 60% saturated fatty acids drawn on the total amount of fatty acids in the triglyceride mixture, and, optionally
ii. free fatty acids;
d. optionally, removing free fatty acids from the fat mixture;
e. optionally, isolating the triglyceride mixture.

2. Method according to claim 1, wherein the oil is an edible oil, preferably a vegetable oil, preferably not palm oil or palm oil-based or palm oil-derived fractions.

3. Method according to claims 1-2, wherein the oil is non-hydrogenated.

4. Method according to claims 1-3, wherein the fatty acid mixture contains more than 90 wt. % of C18:0 fatty acid (stearic acid).

5. Method according to claims 1-4, wherein the ratio of the fatty acid mixture to oil is more than 1.5, based on weight equivalents.

6. Method according to claims 1-5, wherein the transesterification is a one-step transesterification or a two-step transesterification.

7. Method according to claims 1-6, wherein the triglyceride mixture comprises more than 70 wt. % of saturated fatty acids drawn on the total amount of fatty acids in the triglyceride mixture.

8. Method according to claims 1-7, wherein the triglyceride mixture comprises triglycerides of the StStSt type in an amount of more than 30% by weight drawn on the total amount of triglycerides in the triglyceride mixture.

9. Method according to claims 1-8, wherein the ratio (StStSt+StStU)/(StStSt+StStU+StUU) in the triglyceride mixture is more than 0.70.

10. Method according to claims 1-10, wherein in the triglyceride mixture 60% of the fatty acids at the 2-position of the triglyceride is of the C18:0-type.

11. Triglyceride mixture obtainable by the method of any of the claims 1-10.

12. Triglyceride mixture according to claim 11, wherein the ratio (StStSt+StStU)/(StStSt+StStU+StUU) in the triglyceride mixture is more than 0.70.

13. Triglyceride mixture according to claims 11-12, wherein in the triglyceride mixture 50% of the fatty acids at the 2-position of the triglyceride is of the H-type, preferably of the C18:0-type.

14. Triglyceride mixture according to claims 11-13, wherein in the triglyceride mixture has an SFC profile of

| Temperature | % |
|---|---|
| 5° C. | >70 |
| 10° C. | 65-77 |
| 20° C. | 45-62 |
| 30° C. | 30-65 |
| 35° C. | 25-50 |

15. Use of a triglyceride mixture as defined in claims 11-14 in the preparation of a structuring fat through blending and/or interesterification with other fats and/or oils.
